(19) United States
(12) Patent Application Publication
(10) Pub. No.: US 2024/0147301 A1
(43) Pub. Date: May 2, 2024

(54) METHOD AND APPARATUS FOR MULTI-PATH TRANSMISSION SCENARIO 1 BUFFER STATUS REPORTING IN A WIRELESS COMMUNICATION SYSTEM

(71) Applicant: ASUS Technology Licensing Inc., Taipei City (TW)

(72) Inventor: Richard Lee-Chee Kuo, Taipei City (TW)

(21) Appl. No.: 18/379,491

(22) Filed: Oct. 12, 2023

Related U.S. Application Data
(60) Provisional application No. 63/419,452, filed on Oct. 26, 2022.

(51) Int. Cl. H04W 28/02

(52) U.S. Cl. CPC H04W 28/0278; H04W 28/0252; H04W 88/04

(57) ABSTRACT

A method and device for supporting multi-path (MP) transmission are disclosed. In one embodiment, a remote User Equipment (UE) communicates with a network node via a direct path and an indirect path. The remote UE also connects with a relay UE via sidelink (SL) or PC5 interface to support the indirect path. In addition, the remote UE is configured with direct bearers and indirect bearers by the network node. Furthermore, the remote UE transmits a buffer status report (BSR) and a SL-BSR to the network node over the direct path, wherein the BSR includes data volume of at least one of the direct bearers and the SL-BSR includes data volume of at least one of the indirect bearers.

### CROSS-REFERENCE TO RELATED APPLICATIONS

The present Application claims the benefit of U.S. Provisional Patent Application Ser. No. 63/419,452 filed on Oct. 26, 2022, the entire disclosure of which is incorporated herein in its entirety by reference.

### FIELD

This disclosure generally relates to wireless communication networks, and more particularly, to a method and apparatus for multi-path transmission scenario 1 buffer status reporting in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for supporting multi-path (MP) transmission are disclosed. In one embodiment, a remote User Equipment (UE) communicates with a network node via a direct path and an indirect path. The remote UE also connects with a relay UE via sidelink (SL) or PC5 interface to support the indirect path. In addition, the remote UE is configured with direct bearers and indirect bearers by the network node. Furthermore, the remote UE transmits a buffer status report (BSR) and a SL-BSR to the network node over the direct path, wherein the BSR includes data volume of at least one of the direct bearers and the SL-BSR includes data volume of at least one of the indirect bearers.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 16.12.2.1-1 of 3GPP TS 38.300 V17.2.20.

FIG. 6 is a reproduction of FIG. 16.12.5.1-1 of 3GPP TS 38.300 V17.2.20.

FIG. 7 is a reproduction of FIG. 16.12.6.2-1 of 3GPP TS 38.300 V17.2.20.

FIG. 8 is a reproduction of FIG. 5.3.3.1-1 of 3GPP TS 38.331 V17.2.0.

FIG. 9 is a reproduction of FIG. 5.3.3.1-2 of 3GPP TS 38.331 V17.2.0.

FIG. 10 is a reproduction of FIG. 5.3.5.1-1 of 3GPP TS 38.331 V17.2.0.

FIG. 11 is a reproduction of FIG. 5.3.5.1-2 of 3GPP TS 38.331 V17.2.0.

FIG. 12 is a reproduction of FIG. 4.2.2-2 of 3GPP TS 37.340 V16.8.0.

FIG. 13 is a reproduction of FIG. 6.1.3.1-1 of 3GPP TS 38.321 V17.2.0.

FIG. 14 is a reproduction of FIG. 6.1.3.1-2 of 3GPP TS 38.321 V17.2.0.

FIG. 15 is a reproduction of FIG. 6.1.3.33-1 of 3GPP TS 38.321 V17.2.0.

FIG. 16 illustrates a protocol stack for multi-path transmission (Scenario 1) according to one exemplary embodiment.

FIG. 17 illustrates a protocol stack for multi-path transmission (Scenario 2) according to one exemplary embodiment

FIG. 18 illustrates radio bearer configuration and BSR and SL-BSR reporting to support Scenario 1 according to one exemplary embodiment.

FIG. 19 is a flow chart according to one exemplary embodiment.

FIG. 20 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 38.300 V17.2.0, “NR; NR and NR-RAN Overall Description; Stage 2 (Release 17)”; TS 38.331 V17.2.0, “NR; Radio Resource Control (RRC) protocol specification (Release 17)”; TS 37.340 V16.8.0, “Evolved Universal Terrestrial Radio Access (E-UTRA) and NR; Multi-connectivity; Stage 2 (Release 16)”; TS 38.321 V17.2.0, “NR; Medium Access Control (MAC) protocol specification (Release 17)”; RP-213585, “New WID on NR sidelink relay enhancements”, LG Electronics; and R2-2209372, “Discussion on Multi-path for Scenario 1”, CATT. The standards and documents listed above are hereby expressly incorporated by reference in their entirety.

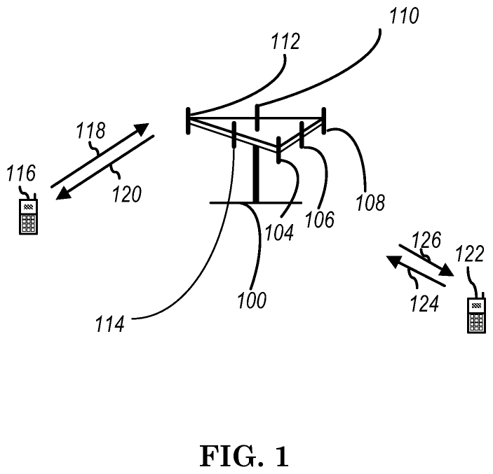

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

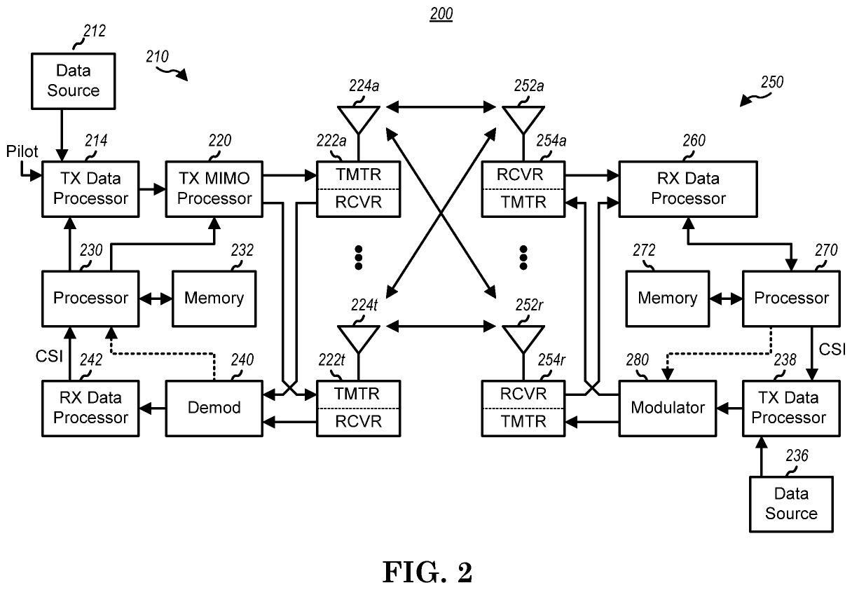

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

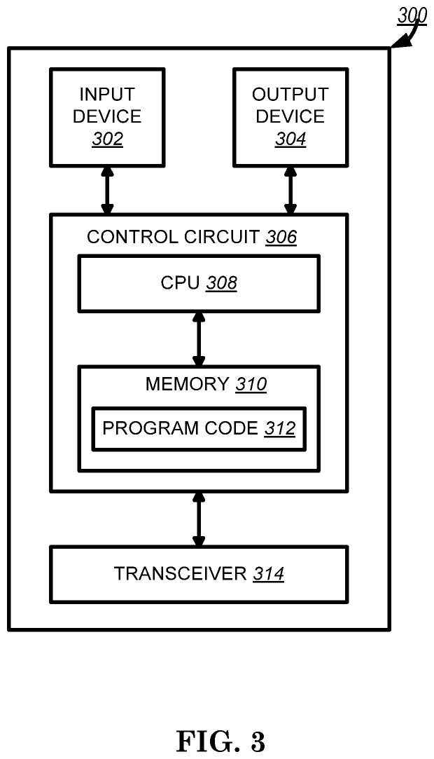

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

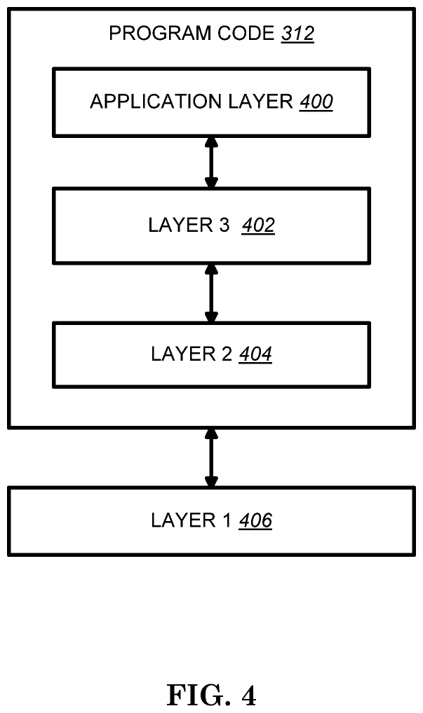

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 38.300 specifies Sidelink Relay. Sidelink resource allocation modes, protocol architecture for L2 UE-to-Network Relay, Radio Resource Control (RRC) Connection Management, and direct to indirect path switching as follows:

5.7 Sidelink

5.7.1 General

Sidelink supports UE-to-UE direct communication using the sidelink resource allocation modes, physical-layer signals/channels, and physical layer procedures below.

5.7.2 Sidelink Resource Allocation Modes

Two sidelink resource allocation modes are supported: mode 1 and mode 2. In mode 1, the sidelink resource allocation is provided by the network. In mode 2, UE decides the SL transmission resources in the resource pool(s).

[ . . . ]

16.12 Sidelink Relay

16.12.1 General

Sidelink relay is introduced to support 5G ProSe UE-to-Network Relay (U2N Relay) function (specified in TS 23.304 [48]) to provide connectivity to the network for U2N Remote UE(s). Both L2 and L3 U2N Relay architectures are supported. The L3 U2N Relay architecture is transparent to the serving NG-RAN of the U2N Relay UE, except for controlling sidelink resources. The detailed architecture and procedures for L3 U2N Relay can be found in TS 23.304 [48].

A U2N Relay UE shall be in RRC_CONNECTED to perform relaying of unicast data.

For L2 U2N Relay operation, the following RRC state combinations are supported:
Both L2 U2N Relay UE and L2 U2N Remote UE shall be in RRC_CONNECTED to perform transmission/reception of relayed unicast data; and
The L2 U2N Relay UE can be in RRC_IDLE, RRC_INACTIVE or RRC_CONNECTED as long as all the L2 U2N Remote UE(s) that are connected to the L2 U2N Relay UE are either in RRC_INACTIVE or in RRC_IDLE.

A single unicast link is established between one L2 U2N Relay UE and one L2 U2N Remote UE. The traffic to the NG-RAN of L2 U2N Remote UE via a given L2 U2N Relay UE and the traffic of the L2 U2N Relay UE shall be separated in different Uu RLC channels.

For L2 U2N Relay, the L2 U2N Remote UE can only be configured to use resource allocation mode 2 (as specified in 5.7.2 and 16.9.3.1) for data to be relayed.

16.12.2 Protocol Architecture

16.12.2.1 L2 UE-to-Network Relay

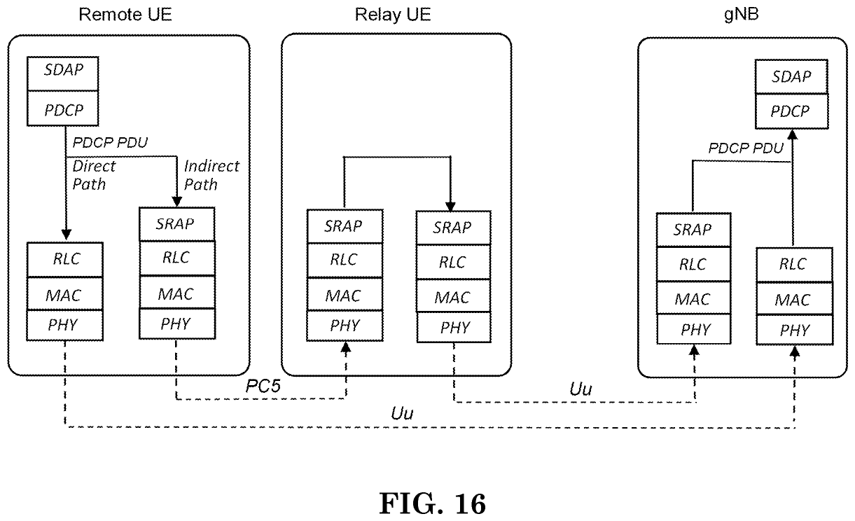

The protocol stacks for the user plane and control plane of L2 U2N Relay architecture are illustrated in FIG. 16.12.2.1-1 and FIG. 16.12.2.1-2. The SRAP sublayer is placed above the RLC sublayer for both CP and UP at both PC5 interface and Uu interface. The Uu SDAP, PDCP and RRC are terminated between L2 U2N Remote UE and gNB, while SRAP, RLC, MAC and PHY are terminated in each hop (i.e., the link between L2 U2N Remote UE and the L2 U2N Relay UE and the link between L2 U2N Relay UE and the gNB).

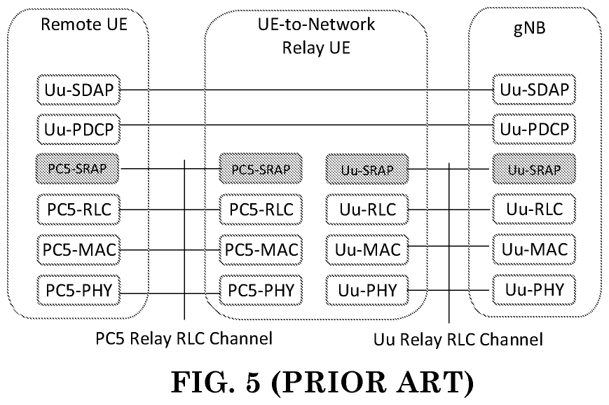

For L2 U2N Relay, the SRAP sublayer over PC5 hop is only for the purpose of bearer mapping. The SRAP sublayer is not present over PC5 hop for relaying the L2 U2N Remote UE's message on BCCH and PCCH. For L2 U2N Remote UE's message on SRB0, the SRAP header is not present over PC5 hop, but the SRAP header is present over Uu hop for both DL and UL.

[FIG. 16.12.2.1-1 of 3GPP TS 38.300 V17.2.20, Entitled “User Plane Protocol Stack for L2 UE-to-Network Relay”, is Reproduced as FIG. 5]

[ . . . ]

For L2 U2N Relay, for uplink:
The Uu SRAP sublayer performs UL bearer mapping between ingress PC5 Relay RLC channels for relaying and egress Uu Relay RLC channels over the L2 U2N Relay UE Uu interface. For uplink relaying traffic, the different end-to-end Uu Radio Bearers (SRBs or DRBs) of the same L2 U2N Remote UE and/or different L2 U2N Remote UEs can be multiplexed over the same egress Uu Relay RLC channel;
The Uu SRAP sublayer supports L2 U2N Remote UE identification for the UL traffic. The identity information of L2 U2N Remote UE end-to-end Uu Radio Bearer and a local Remote UE ID are included in the Uu SRAP header at UL in order for gNB to correlate the received packets for the specific PDCP entity associated with the right end-to-end Uu Radio Bearer of the L2 U2N Remote UE;
The PC5 SRAP sublayer at the L2 U2N Remote UE supports UL bearer mapping between L2 U2N Remote UE end-to-end Uu Radio Bearers and egress PC5 Relay RLC channels.

For L2 U2N Relay, for downlink:
The Uu SRAP sublayer performs DL bearer mapping at gNB to map end-to-end Uu Radio Bearer (SRB, DRB) of L2 U2N Remote UE into Uu Relay RLC channel. The Uu SRAP sublayer performs DL bearer mapping and data multiplexing between multiple end-to-end Radio Bearers (SRBs or DRBs) of a L2 U2N Remote UE and/or different L2 U2N Remote UEs and one Uu Relay RLC channel over the L2 U2N Relay UE Uu interface;
The Uu SRAP sublayer supports L2 U2N Remote UE identification for DL traffic. The identity information of L2 U2N Remote UE end-to-end Uu Radio Bearer and a local Remote UE ID are included into the Uu SRAP header by the gNB at DL for the L2 U2N Relay UE to enable DL bearer mapping between ingress Uu Relay RLC channels and egress PC5 Relay RLC channel;
The PC5 SRAP sublayer at the L2 U2N Relay UE performs DL bearer mapping between ingress Uu Relay RLC channels and egress PC5 Relay RLC channels;
The PC5 SRAP sublayer at the L2 U2N Remote UE correlates the received packets with the right PDCP entity associated with the given end-to-end Radio Bearer of the L2 U2N Remote UE based on the identity information included in the PC5 SRAP header.

A local Remote UE ID is included in both PC5 SRAP header and Uu SRAP header. L2 U2N Relay UE is configured by the gNB with the local Remote UE ID(s) to be used in SRAP header. L2 U2N Remote UE obtains the local Remote ID from the gNB via Uu RRC messages including RRCSetup, RRCReconfiguration, RRCResume and RRCReestablishment.

The end-to-end DRB(s) or end-to-end SRB(s), except SRB0, of L2 U2N Remote UE can be multiplexed to the PC5 Relay RLC channels and Uu Relay RLC channels in both PC5 hop and Uu hop, but an end-to-end DRB and an end-to-end SRB can neither be mapped into the same PC5 Relay RLC channel nor be mapped into the same Uu Relay RLC channel.

It is the gNB responsibility to avoid collision on the usage of local Remote UE ID. The gNB can update the local Remote UE ID by sending the updated local Remote UE ID via RRCReconfiguration message. The serving gNB can perform local Remote UE ID update independent of the PC5 unicast link L2 ID update procedure.

[ . . . ]

16.12.5.1 RRC Connection Management

The L2 U2N Remote UE needs to establish its own PDU sessions/DRBs with the network before user plane data transmission.

The NR sidelink PC5 unicast link establishment procedures can be used to setup a secure unicast link between L2 U2N Remote UE and L2 U2N Relay UE before L2 U2N Remote UE establishes a Uu RRC connection with the network via L2 U2N Relay UE.

The establishment of Uu SRB1/SRB2 and DRB of the L2 U2N Remote UE is subject to Uu configuration procedures for L2 UE-to-Network Relay.

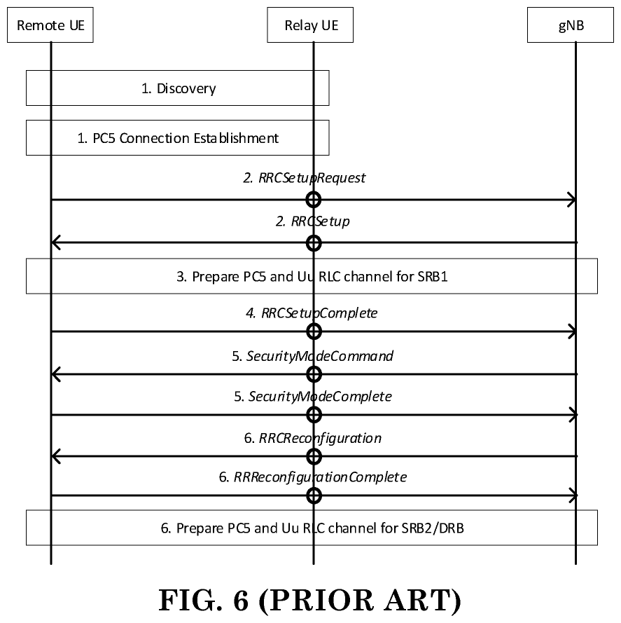

The following high level connection establishment procedure in FIG. 16.12.5.1-1 applies to a L2 U2N Relay and L2 U2N Remote UE:

[FIG. 16.12.5.1-1 of 3GPP TS 38.300 V17.2.20, Entitled “Procedure for L2 U2N Remote UE Connection Establishment”, is Reproduced as FIG. 6]
1. The L2 U2N Remote and L2 U2N Relay UE perform discovery procedure, and establish a PC5-RRC connection using the NR sidelink PC5 unicast link establishment procedure.
2. The L2 U2N Remote UE sends the first RRC message (i.e., RRCSetupRequest) for its connection establishment with gNB via the L2 U2N Relay UE, using a specified PC5 Relay RLC channel configuration. If the L2 U2N Relay UE is not in RRC_CONNECTED, it needs to do its own Uu RRC connection establishment upon reception of a message on the specified PC5 Relay RLC channel. After L2 U2N Relay UE's RRC connection establishment procedure, gNB configures SRB0 relaying Uu Relay RLC channel to the U2N Relay UE. The gNB responds with an RRCSetup message to L2 U2N Remote UE. The RRCSetup message is sent to the L2 U2N Remote UE using SRB0 relaying Uu Relay RLC channel over Uu and a specified PC5 Relay RLC channel over PC5.
NOTE 1: Void.
3. The gNB and L2 U2N Relay UE perform relaying channel setup procedure over Uu. According to the configuration from gNB, the L2 U2N Relay/Remote UE establishes a PC5 Relay RLC channel for relaying of SRB1 towards the L2 U2N Remote/Relay UE over PC5.
4. The RRCSetupComplete message is sent by the L2 U2N Remote UE to the gNB via the L2 U2N Relay UE using SRB1 relaying channel over PC5 and SRB1 relaying channel configured to the L2 U2N Relay UE over Uu. Then the L2 U2N Remote UE is as in RRC_CONNECTED with the gNB.
5. The L2 U2N Remote UE and gNB establish security following the Uu security mode procedure and the security messages are forwarded through the L2 U2N Relay UE.
6. The gNB sends an RRCReconfiguration message to the L2 U2N Remote UE via the L2 U2N Relay UE, to setup the end-to-end SRB2/DRBs of the L2 U2N Remote UE. The L2 U2N Remote UE sends an RRCReconfigurationComplete message to the gNB via the L2 U2N Relay UE as a response. In addition, the gNB may configure additional Uu Relay RLC channels between the gNB and L2 U2N Relay UE, and PC5 Relay RLC channels between L2 U2N Relay UE and L2 U2N Remote UE for the relaying traffic.

[ . . . ]

16.12.6.2 Switching from Direct to Indirect Path

The gNB can select a L2 U2N Relay UE in any RRC state i.e., RRC_IDLE, RRC_INACTIVE, or RRC_CONNECTED, as a target L2 U2N Relay UE for direct to indirect path switch.

For service continuity of L2 U2N Remote UE, the following procedure is used, in case of the L2 U2N Remote UE switching to indirect path via a L2 U2N Relay UE in RRC_CONNECTED:

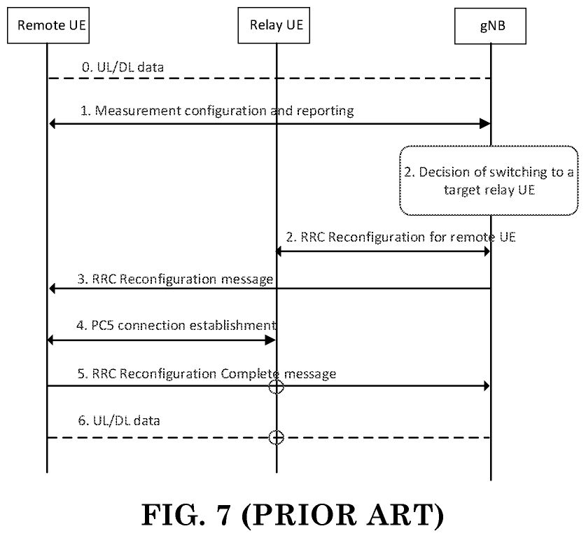

### FIG. 16.12.6.2-1 of 3GPP TS 38.300 V17.2.20, Entitled “Procedure for L2 U2N Remote UE Switching to Indirect Path Via a L2 U2N Relay UE in RRC_CONNECTED”, is Reproduced as FIG. 7

1. The L2 U2N Remote UE reports one or multiple candidate L2 U2N Relay UE(s) and Uu measurements, after it measures/discovers the candidate L2 U2N Relay UE(s):
   The L2 U2N Remote UE filters the appropriate L2 U2N Relay UE(s) according to relay selection criteria before reporting. The L2 U2N Remote UE shall report only the L2 U2N Relay UE candidate(s) that fulfil the higher layer criteria;
   The reporting includes at least a L2 U2N Relay UE ID, a L2 U2N Relay UE's serving cell ID, and a sidelink measurement quantity information. SD-RSRP is used as sidelink measurement quantity.
2. The gNB decides to switch the L2 U2N Remote UE to a target L2 U2N Relay UE. Then the gNB sends an RRCReconfiguration message to the target L2 U2N Relay UE, which includes at least the L2 U2N Remote UE's local ID and L2 ID, Uu and PC5 Relay RLC channel configuration for relaying, and bearer mapping configuration.
3. The gNB sends the RRCReconfiguration message to the L2 U2N Remote UE. The RRCReconfiguration message includes at least the L2 U2N Relay UE ID, Remote UE's local ID, PC5 Relay RLC channel configuration for relay traffic and the associated end-to-end radio bearer(s). The L2 U2N Remote UE stops UP and CP transmission over the direct path after reception of the RRCReconfiguration message from the gNB.
4. The L2 U2N Remote UE establishes PC5 RRC connection with target L2 U2N Relay UE.
5. The L2 U2N Remote UE completes the path switch procedure by sending the RRCReconfigurationComplete message to the gNB via the L2 U2N Relay UE.
6. The data path is switched from direct path to indirect path between the L2 U2N Remote UE and the gNB.

In case the selected L2 U2N Relay UE for direct to indirect path switch is in RRC_IDLE or RRC_INACTIVE, after receiving the path switch command, the L2 U2N Remote UE establishes a PC5 link with the L2 U2N Relay UE and sends the RRCReconfigurationComplete message via the L2 U2N Relay UE, which triggers the L2 U2N Relay UE to enter RRC_CONNECTED state. The procedure for L2 U2N Remote UE switching to indirect path in FIG. 16.12.6.2-1 can be also applied for the case that the selected L2 U2N Relay UE for direct to indirect path switch is in RRC_IDLE or RRC_INACTIVE with the exception that the RRCReconfiguration message is sent from the gNB to the L2 U2N Relay UE after the L2 U2N Relay UE enters RRC_CONNECTED state, which happens between step 4 and step 5.

3GPP TS 38.331 specifies a RRC connection establishment for establishing a RRC connection between a UE and a gNB and a RRC reconfiguration for providing radio resource configuration to support L2 UE-to-Network Relay as follows:

5.3.3 RRC Connection Establishment

5.3.3.1 General

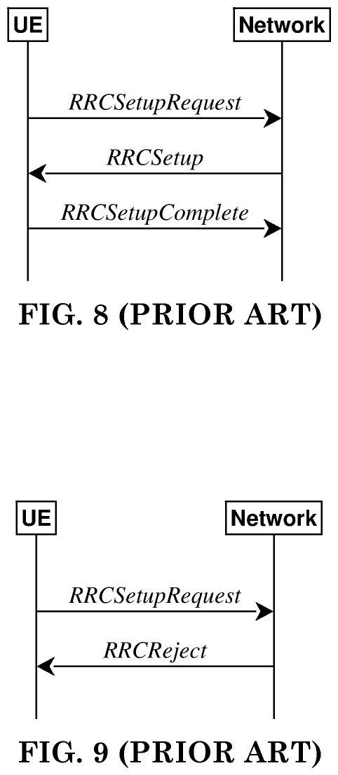

### FIG. 5.3.3.1-1 of 3GPP TS 38.331 V17.2.0, Entitled “RRC Connection Establishment, Successful”, is Reproduced as FIG. 8

### FIG. 5.3.3.1-2 of 3GPP TS 38.331 V17.2.0, Entitled “RRC Connection Establishment, Network Reject”, is Reproduced as FIG. 9

The purpose of this procedure is to establish an RRC connection. RRC connection establishment involves SRB1 establishment. The procedure is also used to transfer the initial NAS dedicated information/message from the UE to the network.

The network applies the procedure e.g. as follows:
When establishing an RRC connection;
When UE is resuming or re-establishing an RRC connection, and the network is not able to retrieve or verify the UE context. In this case, UE receives RRCSetup and responds with RRCSetupComplete.

[ . . . ]

5.3.5 RRC Reconfiguration

5.3.5.1 General

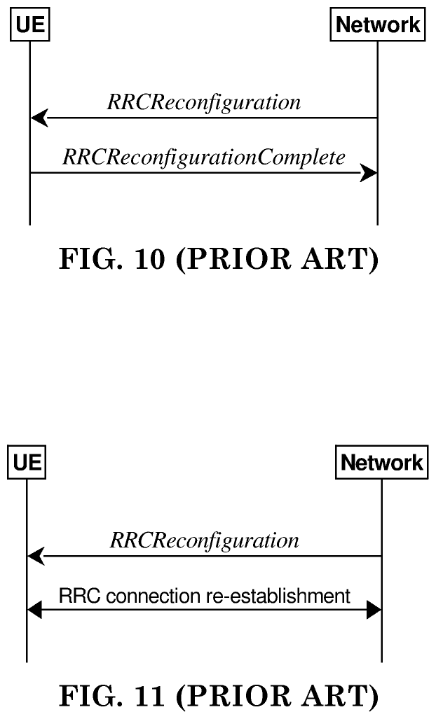

### FIG. 5.3.5.1-1 of 3GPP TS 38.331 V17.2.0, Entitled “RRC Reconfiguration, Successful”, is Reproduced as FIG. 10

### FIG. 5.3.5.1-2 of 3GPP TS 38.331 V17.2.0, Entitled “RRC Reconfiguration, Failure”, is Reproduced as FIG. 11

The purpose of this procedure is to modify an RRC connection, e.g. to establish/modify/release RBs/BH RLC channels/Uu Relay RLC channels/PC5 Relay RLC channels, to perform reconfiguration with sync, to setup/modify/release measurements, to add/modify/release SCells and cell groups, to add/modify/release conditional handover configuration, to add/modify/release conditional PSCell change or conditional PSCell addition configuration. As part of the procedure, NAS dedicated information may be transferred from the Network to the UE.

[ . . . ]

5.3.5.2 Initiation

The Network may initiate the RRC reconfiguration procedure to a UE in RRC_CONNECTED. The Network applies the procedure as follows:
the establishment of RBs (other than SRB1, that is established during RRC connection establishment) is performed only when AS security has been activated;
the establishment of BH RLC Channels for IAB is performed only when AS security has been activated;
the establishment of Uu Relay RLC channels and PC5 Relay RLC channels (other than SL-RLC0 and SL-RLC1, that is established before RRC connection establishment) for L2 U2N Relay UE is performed only when AS security has been activated, and the establishment of PC5 Relay RLC channels for L2 U2N Remote UE (other than SL-RLC0 and SL-RLC1, that is established before RRC connection establishment) is performed only when AS security has been activated;
the addition of Secondary Cell Group and SCells is performed only when AS security has been activated;
the reconfigurationWithSync is included in secondaryCellGroup only when at least one RLC bearer or BH RLC channel is setup in SCG;
the reconfigurationWithSync is included in masterCellGroup only when AS security has been activated, and SRB2 with at least one DRB or multicast MRB or, for IAB, SRB2, are setup and not suspended;
the conditionalReconfiguration for CPC is included only when at least one RLC bearer is setup in SCG;
the conditionalReconfiguration for CHO or CPA is included only when AS security has been activated, and SRB2 with at least one DRB or multicast MRB or, for IAB, SRB2, are setup and not suspended.

[ . . . ]

### 6.2.2 Message Definitions

[ . . . ]

RRCReconfiguration

The RRCReconfiguration message is the command to modify an RRC connection. It may convey information for measurement configuration, mobility control, radio resource configuration (including RBs, MAC main configuration and physical channel configuration) and AS security configuration.

[...]

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING CellGroupConfig) |

OPTIONAL, -- Cond SCG

| | |
|---|---|
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}
[...]

| | |
|---|---|
| RRCReconfiguration-v1700-IEs ::= | SEQUENCE { |
| otherConfig-v1700 | OtherConfig-v1700 |

OPTIONAL, -- Need M

| | |
|---|---|
| sl-L2RelayUE-Config-r17 | SetupRelease { SL-L2RelayUE-Config-r17 } |

OPTIONAL, -- Need M

| | |
|---|---|
| sl-L2RemoteUE-Config-r17 | SetupRelease { SL-L2RemoteUE-Config-r17 } |

OPTIONAL, -- Need M

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG-ConfigNR-r17} |

OPTIONAL, -- Need M

| | |
|---|---|
| needForGapNCSG-ConfigEUTRA-r17 | SetupRelease {NeedForGapNCSG-ConfigEUTRA-r17} |

OPTIONAL, -- Need M

| | |
|---|---|
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| scg-State-r17 | ENUMERATED { deactivated } |

OPTIONAL, -- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG-RequestUL-TDOA-Config-r17} |

OPTIONAL, -- Need M

| | |
|---|---|
| nonCriticalExtension | SEQUENCE { } |

OPTIONAL
}
[...]

6.3.2 Radio Resource Control Information Elements

[ . . . ]

CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

### CellGroupConfig Information Element

-- ASN1START
-- TAG-CELLGROUPCONFIG-START
-- Configuration of one Cell-Group:

| | |
|---|---|
| CellGroupConfig ::= | SEQUENCE { |
| cellGroupId | CellGroupId, |
| rlc-BearerToAddModList | SEQUENCE (SIZE(1..maxLC-ID)) OF RLC-BearerConfig |

OPTIONAL, -- Need N

| | |
|---|---|
| rlc-BearerToReleaseList | SEQUENCE (SIZE(1..maxLC-ID)) OF |
| LogicalChannelIdentity | OPTIONAL, -- Need N |
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE (1..maxNrofSCells)) OF SCellConfig |

OPTIONAL, -- Need N

| | |
|---|---|
| sCellToReleaseList | SEQUENCE (SIZE (1..maxNrofSCells)) OF SCellIndex |

OPTIONAL, -- Need N
[...],

RadioBearerConfig

The IE RadioBearerConfig is used to add, modify and release signalling and/or data radio bearers. Specifically, this IE carries the parameters for PDCP and, if applicable, SDAP entities for the radio bearers.

| | |
|---|---|
| RadioBearerConfig ::= | SEQUENCE { |
| srb-ToAddModList | SRB-ToAddModList |

OPTIONAL, -- Cond HO-Conn

| | |
|---|---|
| srb3-ToRelease | ENUMERATED{true} |

OPTIONAL, -- Need N

| | |
|---|---|
| drb-ToAddModList | DRB-ToAddModList |

OPTIONAL, -- Cond HO-toNR

| | |
|---|---|
| drb-ToReleaseList | DRB-ToReleaseList |

OPTIONAL, -- Need N

| | |
|---|---|
| securityConfig | SecurityConfig |

OPTIONAL, -- Need M
[...]
}

| | |
|---|---|
| SRB-ToAddModList ::= | SEQUENCE (SIZE (1..2)) OF SRB-ToAddMod |
| SRB-ToAddMod ::= | SEQUENCE { |
| srb-Identity | SRB-Identity, |
| reestablishPDCP | ENUMERATED{true} |

OPTIONAL, -- Need N

| | |
|---|---|
| discardOnPDCP | ENUMERATED{true} |

OPTIONAL, -- Need N

| | |
|---|---|
| pdcp-Config | PDCP-Config |

OPTIONAL, -- Cond PDCP
[...]
}

| | |
|---|---|
| DRB-ToAddModList ::= | SEQUENCE (SIZE (1..maxDRB)) OF DRB-ToAddMod |
| DRB-ToAddMod ::= | SEQUENCE { |
| cnAssociation | CHOICE { |
| eps-BearerIdentity | INTEGER (0..15), |
| sdap-Config | SDAP-Config |

}
OPTIONAL, -- Cond DRBSetup

| | |
|---|---|
| drb-Identity | DRB-Identity, |
| reestablishPDCP | ENUMERATED{true} |

OPTIONAL, -- Need N

| | |
|---|---|
| recoverPDCP | ENUMERATED{true} |

OPTIONAL, -- Need N

| | |
|---|---|
| pdcp-Config | PDCP-Config |

```
OPTIONAL, -- Cond PDCP
  [...],
    [[
```

| | |
|---|---|
| daps-Config-r16 | ENUMERATED{true} |

OPTIONAL -- Cond DAPS
]]
}

| | |
|---|---|
| DRB-ToReleaseList ::= | SEQUENCE (SIZE (1..maxDRB)) OF DRB-Identity |
| SecurityConfig ::= | SEQUENCE { |
| securityAlgorithmConfig | SecurityAlgorithmConfig |

OPTIONAL, -- Cond RBTermChange1

| | |
|---|---|
| keyToUse | ENUMERATED{master, secondary} |

OPTIONAL, -- Cond RBTermChange
[...]
}
-- TAG-RADIOBEARERCONFIG-STOP
-- ASN1STOP
[...]

RLC-BearerConfig

The IE RLC-BearerConfig is used to configure an RLC entity, a corresponding logical channel in MAC and the linking to a PDCP entity (served radio bearer).

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |

}
OPTIONAL, -- Cond LCH-SetupOnly

| | |
|---|---|
| reestablishRLC | ENUMERATED {true} |

OPTIONAL, -- Need N

| | |
|---|---|
| rlc-Config | RLC-Config |

OPTIONAL, -- Cond LCH-Setup

| | |
|---|---|
| mac-LogicalChannelConfig | LogicalChannelConfig |

```
OPTIONAL, -- Cond LCH-Setup
  [...],
  [[
```

| | |
|---|---|
| rlc-Config-v1610 | RLC-Config-v1610 |

```
OPTIONAL -- Need R
  ]],
  [[
```

| | |
|---|---|
| rlc-Config-v1700 | RLC-Config-v1700 |

OPTIONAL, -- Need R

| | |
|---|---|
| logicalChannelIdentityExt-r17 | LogicalChannelIdentityExt-r17 |

OPTIONAL, -- Cond LCH-SetupModMRB

| | |
|---|---|
| multicastRLC-BearerConfig-r17 | MulticastRLC-BearerConfig-r17 |

OPTIONAL, -- Cond LCH-SetupOnlyMRB

| | |
|---|---|
| servedRadioBearerSRB4-r17 | SRB-Identity-v1700 |

OPTIONAL -- Need N
]]
}
[...]

PDCP-Config

The IE PDCP-Config is used to set the configurable PDCP parameters for signalling, MBS multicast and data radio bearers.

-- ASN1START
-- TAG-PDCP-CONFIG-START

| | |
|---|---|
| PDCP-Config ::= | SEQUENCE { |

| | |
|---|---|
| drb | SEQUENCE { |

| | |
|---|---|
| discardTimer | ENUMERATED {ms10, ms20, ms30, ms40, ms50, ms60, ms75, ms100, |

ms150, ms200,

ms250, ms300, ms500, ms750, ms1500, infinity}

OPTIONAL, -- Cond Setup

| | |
|---|---|
| pdcp-SN-SizeUL | ENUMERATED {len12bits, len18bits} |

OPTIONAL, -- Cond Setup1

| | |
|---|---|
| pdcp-SN-SizeDL | ENUMERATED {len12bits, len18bits} |

OPTIONAL, -- Cond Setup2

| | |
|---|---|
| headerCompression | CHOICE { |

| | |
|---|---|
| notUsed | NULL, |
| rohc | SEQUENCE { |

| | |
|---|---|
| maxCID | INTEGER (1..16383) |

DEFAULT 15,

| | |
|---|---|
| profiles | SEQUENCE { |

| profile0x0001 | BOOLEAN, |
|---|---|
| profile0x0002 | BOOLEAN, |
| profile0x0003 | BOOLEAN, |
| profile0x0004 | BOOLEAN, |
| profile0x0006 | BOOLEAN, |
| profile0x0101 | BOOLEAN, |
| profile0x0102 | BOOLEAN, |
| profile0x0103 | BOOLEAN, |
| profile0x0104 | BOOLEAN |
| }, | |
| drb-ContinueROHC | ENUMERATED { true } |

| OPTIONAL | -- Need N | |
|---|---|---|
| | }, | |
| | uplinkOnlyROHC | SEQUENCE { |

| | |
|---|---|
| maxCID | INTEGER (1..16383) |

DEFAULT 15,

| | |
|---|---|
| profiles | SEQUENCE { |

| profile0x0006 | BOOLEAN |
|---|---|
| }, | |
| drb-ContinueROHC | ENUMERATED { true } |

| | |
|---|---|
| OPTIONAL | -- Need N |
| | }, |
| | [...] |

},

| | |
|---|---|
| integrityProtection | ENUMERATED { enabled } |

| | |
|---|---|
| OPTIONAL, | -- Cond ConnectedTo5GC1 |

| | |
|---|---|
| statusReportRequired | ENUMERATED { true } |

| | |
|---|---|
| OPTIONAL, | -- Cond Rlc-AM-UM |

| | |
|---|---|
| outOfOrderDelivery | ENUMERATED { true } |

| | |
|---|---|
| OPTIONAL | -- Need R |

}

| | |
|---|---|
| OPTIONAL, | -- Cond DRB |

| | |
|---|---|
| moreThanOneRLC | SEQUENCE { |

| | |
|---|---|
| primaryPath | SEQUENCE { |

| | cellGroup | CellGroupId |
|---|---|---|
| OPTIONAL, | -- Need R | |
| | logicalChannel | LogicalChannelIdentity |

| | |
|---|---|
| OPTIONAL | -- Need R |

},

| | |
|---|---|
| ul-DataSplitThreshold | UL-DataSplitThreshold |

| | |
|---|---|
| OPTIONAL, | -- Cond SplitBearer |

| | |
|---|---|
| pdcp-Duplication | BOOLEAN |

| | |
|---|---|
| OPTIONAL | -- Need R |

}

| | |
|---|---|
| OPTIONAL, | -- Cond MoreThanOneRLC |

| | |
|---|---|
| t-Reordering | ENUMERATED { |

```
    ms0, ms1, ms2, ms4, ms5, ms8, ms10, ms15, ms20, ms30, ms40,
    ms50, ms60, ms80, ms100, ms120, ms140, ms160, ms180, ms200,
```

ms220,

```
    ms240, ms260, ms280, ms300, ms500, ms750, ms1000, ms1250,
    ms1500, ms1750, ms2000, ms2250, ms2500, ms2750,
    ms3000, spare28, spare27, spare26, spare25, spare24,
    spare23, spare22, spare21, spare20,
    spare19, spare18, spare17, spare16, spare15, spare14,
    spare13, spare12, spare11, spare10, spare09,
    spare08, spare07, spare06, spare05, spare04, spare03,
    spare02, spare01 }
```

```
OPTIONAL, -- Need S
  [...],
  [[
```

| | |
|---|---|
| cipheringDisabled | ENUMERATED {true} |

| | |
|---|---|
| OPTIONAL | -- Cond ConnectedTo5GC |

```
  ]],
  [[
```

| | |
|---|---|
| discardTimerExt-r16 | SetupRelease { DiscardTimerExt-r16 } |

| | |
|---|---|
| OPTIONAL, | -- Cond DRB2 |

| | |
|---|---|
| moreThanTwoRLC-DRB-r16 | SEQUENCE { |

| | |
|---|---|
| splitSecondaryPath-r16 | LogicalChannelIdentity |

| | |
|---|---|
| OPTIONAL, | -- Cond SplitBearer2 |

| | |
|---|---|
| duplicationState-r16 | SEQUENCE (SIZE (3)) OF BOOLEAN |

| | |
|---|---|
| OPTIONAL | -- Need S |

}

| | |
|---|---|
| OPTIONAL, | -- Cond MoreThanTwoRLC-DRB |

| | |
|---|---|
| ethernetHeaderCompression-r16 | SetupRelease { EthernetHeaderCompression-r16 } |

| | |
|---|---|
| OPTIONAL | -- Need M |

```
  ]],
  [[
```

| | |
|---|---|
| survivalTimeStateSupport-r17 | ENUMERATED {true} |

| | |
|---|---|
| OPTIONAL, | -- Cond Drb-Duplication |

| | |
|---|---|
| uplinkDataCompression-r17 | SetupRelease { UplinkDataCompression-r17 } |

| | |
|---|---|
| OPTIONAL, | -- Cond Rlc-AM |

| | |
|---|---|
| discardTimerExt2-r17 | SetupRelease { DiscardTimerExt2-r17 } |

| | |
|---|---|
| OPTIONAL, | -- Need M |

| | |
|---|---|
| initialRX-DELIV-r17 | BIT STRING (SIZE (32)) |

| | |
|---|---|
| OPTIONAL | -- Cond MRB-Initialization |

]]
}

| | |
|---|---|
| EthernetHeaderCompression-r16 ::= | SEQUENCE { |

| | |
|---|---|
| ehc-Common-r16 | SEQUENCE { |
| ehc-CID-Length-r16 | ENUMERATED { bits7, bits15 }, |

```
    [...]
  },
```

| | |
|---|---|
| ehc-Downlink-r16 | SEQUENCE { |

| | |
|---|---|
| drb-ContinueEHC-DL-r16 | ENUMERATED { true } |

| | |
|---|---|
| OPTIONAL, | -- Need N |

```
    [...]
  }
```

| | |
|---|---|
| OPTIONAL, | -- Need M |

| | |
|---|---|
| ehc-Uplink-r16 | SEQUENCE { |

| | |
|---|---|
| maxCID-EHC-UL-r16 | INTEGER (1..32767), |
| drb-ContinueEHC-UL-r16 | ENUMERATED { true } |

| | |
|---|---|
| OPTIONAL, | -- Need N |

```
    [...]
  }
```

| | |
|---|---|
| OPTIONAL | -- Need M |

}
UL-DataSplitThreshold ::= ENUMERATED {

b0, b100, b200, b400, b800, b1600, b3200, b6400,

b12800, b25600, b51200, b102400, b204800,

b409600, b819200, b1228800, b1638400, b2457600,

b3276800, b4096000, b4915200, b5734400,

b6553600, infinity, spare8, spare7, spare6, spare5,

spare4, spare3, spare2, spare1}
DiscardTimerExt-r16 ::= ENUMERATED {ms0dot5, ms1, ms2, ms4, ms6, ms8, spare2, spare1}
DiscardTimerExt2-r17 ::= ENUMERATED {ms2000, spare3, spare2, spare1}

| | |
|---|---|
| UplinkDataCompression-r17 ::= | CHOICE { |

| | |
|---|---|
| newSetup | SEQUENCE { |

| | |
|---|---|
| bufferSize-r17 | ENUMERATED {kbyte2, kbyte4, kbyte8, spare1}, |
| dictionary-r17 | ENUMERATED {sip-SDP, operator} |

| | |
|---|---|
| OPTIONAL | -- Need N |

},

| | |
|---|---|
| drb-ContinueUDC | NULL |

}
-- TAG-PDCP-CONFIG-STOP
-- ASN1 STOP
[...]

LogicalChannelConfig

The IE LogicalChannelConfig is used to configure the logical channel parameters.

-- ASN1START
-- TAG-LOGICALCHANNELCONFIG-START

| | |
|---|---|
| LogicalChannelConfig ::= | SEQUENCE { |

| | |
|---|---|
| ul-SpecificParameters | SEQUENCE { |
| priority | INTEGER (1..16), |
| prioritisedBitRate | ENUMERATED {kBps0, kBps8, kBps16, kBps32, kBps64, |

kBps128, kBps256, kBps512,

kBps1024, kBps2048, kBps4096, kBps8192, kBps16384,

kBps32768, kBps65536, infinity},

| | |
|---|---|
| bucketSizeDuration | ENUMERATED {ms5, ms10, ms20, ms50, ms100, ms150, |

ms300, ms500, ms1000,

spare7, spare6, spare5, spare4,

spare3,spare2, spare1},

| | |
|---|---|
| allowedServingCells | SEQUENCE (SIZE (1..maxNrofServingCells-1)) OF |

ServCellIndex
OPTIONAL, -- Cond PDCP-CADuplication

| | |
|---|---|
| allowedSCS-List | SEQUENCE (SIZE (1..maxSCSs)) OF SubcarrierSpacing |

OPTIONAL, -- Need R

| | |
|---|---|
| maxPUSCH-Duration | ENUMERATED {ms0p02, ms0p04, ms0p0625, ms0p125, |

ms0p25, ms0p5, ms0p01-v1700, spare1}
OPTIONAL, -- Need R

| | |
|---|---|
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | |
|---|---|
| schedulingRequestID | SchedulingRequestId |

OPTIONAL, -- Need R

| | |
|---|---|
| logicalChannelSR-Mask | BOOLEAN, |
| logicalChannelSR-DelayTimerApplied | BOOLEAN, |

...,

| | |
|---|---|
| bitRateQueryProhibitTimer | ENUMERATED {s0, s0dot4, s0dot8, s1dot6, s3, s6, s12, s30} |

OPTIONAL, -- Need R
[[

| | |
|---|---|
| allowedCG-List-r16 | SEQUENCE (SIZE (0.. maxNrofConfiguredGrantConfigMAC- |

1-r16)) OF ConfiguredGrantConfigIndexMAC-r16
OPTIONAL, -- Need S

| | |
|---|---|
| allowedPHY-PriorityIndex-r16 | ENUMERATED {p0, p1} |

```
OPTIONAL -- Need S
    ]],
    [[
```

| | |
|---|---|
| logicalChannelGroupIAB-Ext-r17 | INTEGER (0..maxLCG-ID-IAB-r17) |

OPTIONAL, -- Need R

| | |
|---|---|
| allowedHARQ-mode-r17 | ENUMERATED {harqModeA, harqModeB} |

```
OPTIONAL -- Need R
    ]]
  }
OPTIONAL, -- Cond UL
  ...,
  [[
```

| | |
|---|---|
| channelAccessPriority-r16 | INTEGER (1..4) |

OPTIONAL, -- Need R

| | |
|---|---|
| bitRateMultiplier-r16 | ENUMERATED {x40, x70, x100, x200} |

OPTIONAL -- Need R
]]
}
-- TAG-LOGICALCHANNELCONFIG-STOP
-- ASN1STOP
[...]

6.3.5 Sidelink Information Elements

[ . . . ]

SL-L2RelayUE-Config

The IE SL-L2RelayUE-Config is used to configure L2 U2N relay operation related configurations used by L2 U2N Relay UE, e.g. SRAP-Config.

-- ASN1START
-- TAG-SL-L2RELAYUE-CONFIG-START

| | |
|---|---|
| SL-L2RelayUE-Config-r17 ::= | SEQUENCE { |
| sl-RemoteUE-ToAddModList-r17 | SEQUENCE (SIZE (1..maxNrofRemoteUE-r17)) OF SL-RemoteUE- |

ToAddMod-r17 OPTIONAL, -- Need N

| | |
|---|---|
| sl-RemoteUE-ToReleaseList-r17 | SEQUENCE (SIZE (1..maxNrofRemoteUE-r17)) OF SL- |
| DestinationIdentity-r16 OPTIONAL, | -- Need N |

[...]
}

| | |
|---|---|
| SL-RemoteUE-ToAddMod-r17 ::= | SEQUENCE { |
| sl-L2IdentityRemote-r17 | SL-DestinationIdentity-r16, |
| sl-SRAP-Config-Relay-r17 | SL-SRAP-Config-r17 |

OPTIONAL, -- Need M
[...]
}
-- TAG-SL-L2RELAYUE-CONFIG-STOP
-- ASN1 STOP

The IE SL-L2RemoteUE-Config is Used to Configure L2 U2N Relay Operation Related Configurations Used by L2 U2N Remote UE, e.g. SRAP-Config.

| -- ASN1START | |
|---|---|
| -- TAG-SL-L2REMOTEUE-CONFIG-START | |
| SL-L2RemoteUE-Config-r17 ::= | SEQUENCE { |
| sl-SRAP-ConfigRemote-r17 | SL-SRAP-Config-r17 |
| OPTIONAL, --Need M | |
| sl-UEIdentityRemote-r17 | RNTI-Value |

OPTIONAL, -- Cond FirstRRCReconfig
[...]
}
-- TAG-SL-L2REMOTEUE-CONFIG-STOP
-- ASN1STOP
[...]

SL-SRAP-Config

The IE SL-SRAP-Config is used to set the configurable SRAP parameters used by L2 U2N Relay UE and L2 U2N Remote UE as specified in TS 38.351 [66].

-- ASN1START
-- TAG-SL-SRAP-CONFIG-START

| | |
|---|---|
| SL-SRAP-Config-r17 ::= | SEQUENCE { |
| sl-LocalIdentity-r17 | INTEGER (0..255) |

OPTIONAL, -- Need M

| | |
|---|---|
| sl-MappingToAddModList-r17 | SEQUENCE (SIZE (1..maxLC-ID)) OF SL-MappingToAddMod- |

| | |
|---|---|
| r17 | OPTIONAL, -- Need N |

| | |
|---|---|
| sl-MappingToReleaseList-r17 | SEQUENCE (SIZE (1..maxLC-ID)) OF SL-RemoteUE-RB- |

| | |
|---|---|
| Identity-r17 | OPTIONAL, -- Need N |

[...]
}

| | |
|---|---|
| SL-MappingToAddMod-r17 ::= | SEQUENCE { |
| sl-RemoteUE-RB-Identity-r17 | SL-RemoteUE-RB-Identity-r17, |
| sl-EgressRLC-ChannelUu-r17 | Uu-RelayRLC-ChannelID-r17 |

OPTIONAL, -- Cond L2RelayUE

| | |
|---|---|
| sl-EgressRLC-ChannelPC5-r17 | SL-RLC-ChannelID-r17 |

OPTIONAL, -- Need N
[...]
}

| | |
|---|---|
| SL-RemoteUE-RB-Identity-r17 ::= | CHOICE { |
| srb-Identity-r17 | INTEGER (0..3), |
| drb-Identity-r17 | DRB-Identity, |

[...]
}
-- TAG-SL-SRAP-CONFIG-STOP
-- ASN1STOP

3GPP TS 37.340 specifies dual connectivity (DC) for Release 16. The related specifications are quoted below:

4.1.3.3 NR-NR Dual Connectivity

NG-RAN supports NR-NR Dual Connectivity (NR-DC), in which a UE is connected to one gNB that acts as a MN and another gNB that acts as a SN. In addition, NR-DC can also be used when a UE is connected to a single gNB, acting both as a MN and as a SN, and configuring both MCG and SCG.

[ . . . ]

4.2.2 User Plane

In MR-DC, from a UE perspective, three bearer types exist: MCG bearer, SCG bearer and split bearer. These three bearer types are depicted in FIG. 4.2.2-1 for MR-DC with EPC (EN-DC) and in FIG. 4.2.2-2 for MR-DC with 5GC (NGEN-DC, NE-DC and NR-DC). [ . . . ]

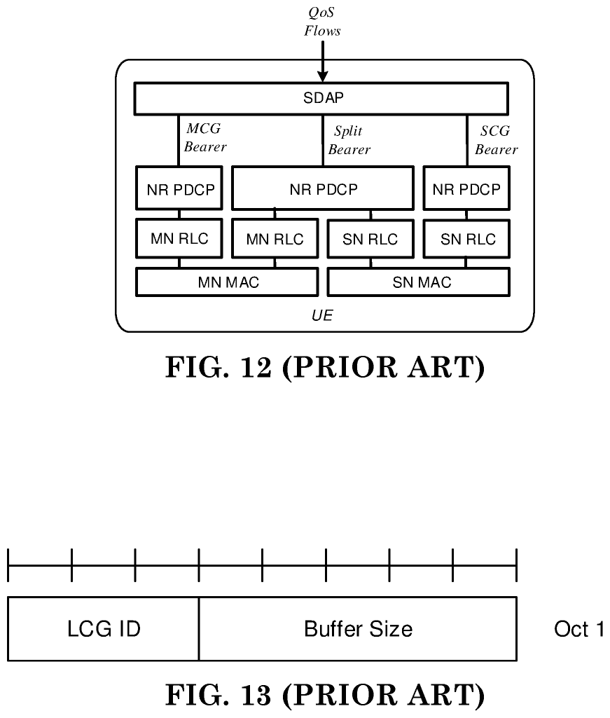

### FIG. 4.2.2-2 of 3GPP TS 37.340 V16.8.0, Entitled “Radio Protocol Architecture for MCG, SCG and Split Bearers from a UE Perspective in MR-DC with 5GC (NGEN-DC, NE-DC and NR-DC)”, is Reproduced as FIG. 12

[ . . . ]

6.1 MAC Sublayer

In MR-DC, the UE is configured with two MAC entities: one MAC entity for the MCG and one MAC entity for the SCG. The serving cells of the MCG other than the PCell can only be activated/deactivated by the MAC Control Element received on MCG, and the serving cells of the SCG other than PSCell can only be activated/deactivated by the MAC Control Element received on SCG. The MAC entity applies the bitmap for the associated cells of either MCG or SCG. PSCell in SCG is always activated like the PCell (i.e. deactivation timer is not applied to PSCell). With the exception of PUCCH SCell, one deactivation timer is configured per SCell by RRC.

In MR-DC, semi-persistent scheduling (SPS) resources and configured grant (CG) resources can be configured on serving cells in both MCG and SCG.

In MR-DC, for 4-step RA type, contention based random access (CBRA) procedure is supported on both PCell and PSCell while contention free random access (CFRA) procedure is supported on all serving cells in both MCG and SCG. For 2-step RA type, CBRA can be supported on the PCell, if the MN is a gNB (i.e. for NE-DC and NR-DC) and on the PSCell, if the SN is a gNB (i.e, for EN-DC, NGEN-DC and NR-DC) while CFRA is only supported on the PCell, if the MN is a gNB (i.e. for NE-DC and NR-DC).

In MR-DC, the BSR configuration, triggering and reporting are independently performed per cell group. For split bearers, the PDCP data is considered in BSR in the cell group(s) configured by RRC.

[ . . . ]

3GPP TS 38.321 specifies Buffer Status Reporting as follows:

5.4.5 Buffer Status Reporting

The Buffer Status reporting (BSR) procedure is used to provide the serving gNB with information about UL data volume in the MAC entity.

RRC configures the following parameters to control the BSR:
periodicBSR-Timer;
retxBSR-Timer;
logicalChannelSR-DelayTimerApplied;
logicalChannelSR-DelayTimer;
logicalChannelSR-Mask;
logicalChannelGroup, logicalChannelGroup-IAB-Ext;
sdt-LogicalChannelSR-DelayTimer.

Each logical channel may be allocated to an LCG using the logicalChannelGroup. The maximum number of LCGs is eight except for IAB-MTs configured with logicalChannelGroup-IAB-Ext, for which the maximum number of LCGs is 256.

The MAC entity determines the amount of UL data available for a logical channel according to the data volume calculation procedure in TSs 38.322 [3] and 38.323 [4].

A BSR shall be triggered if any of the following events occur for activated cell group:
UL data, for a logical channel which belongs to an LCG, becomes available to the MAC entity; and either
this UL data belongs to a logical channel with higher priority than the priority of any logical channel containing available UL data which belong to any LCG; or
none of the logical channels which belong to an LCG contains any available UL data. in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.
NOTE 1: When Regular BSR triggering events occur for multiple logical channels simultaneously, each logical channel triggers one separate Regular BSR.

For Regular BSR, the MAC entity shall:
1> if the BSR is triggered for a logical channel for which logicalChannelSR-DelayTimerApplied with value true is configured by upper layers and SDT procedure is not on-going according to clause 5.27:
   2> start or restart the logicalChannelSR-DelayTimer.
1> else if BSR is triggered for a logical channel for which logicalChannelSR-DelayTimerApplied with value true is configured by upper layers and SDT procedure is on-going according to clause 5.27:
   2> start or restart logicalChannelSR-DelayTimer with the value as configured by the sdt-LogicalChannelSR-DelayTimer.
1> else:
   2> if running, stop the logicalChannelSR-DelayTimer.

For Regular and Periodic BSR, the MAC entity for which logicalChannelGroup-IAB-Ext is not configured by upper layers shall:
1> if more than one LCG has data available for transmission when the MAC PDU containing the BSR is to be built:
   2> report Long BSR for all LCGs which have data available for transmission.
1> else:
   2> report Short BSR.

For Regular and Periodic BSR, the MAC entity for which logicalChannelGroup-IAB-Ext is configured by upper layers shall:
1> if more than one LCG has data available for transmission when the MAC PDU containing the BSR is to be built:
   2> if the maximum LCG ID among the configured LCGs is 7 or lower:
      3> report Long BSR for all LCGs which have data available for transmission.
   2> else:
      3> report Extended Long BSR for all LCGs which have data available for transmission.
1> else:
   2> report Extended Short BSR.

For Padding BSR, the MAC entity for which logicalChannelGroup-IAB-Ext is not configured by upper layers shall:
1> if the number of padding bits is equal to or larger than the size of the Short BSR plus its subheader but smaller than the size of the Long BSR plus its subheader:
   2> if more than one LCG has data available for transmission when the BSR is to be built:
      3> if the number of padding bits is equal to the size of the Short BSR plus its subheader:
         4> report Short Truncated BSR of the LCG with the highest priority logical channel with data available for transmission.
      3> else:
         4> report Long Truncated BSR of the LCG(s) with the logical channels having data available for transmission following a decreasing order of the highest priority logical channel (with or without data available for transmission) in each of these LCG(s), and in case of equal priority, in increasing order of LCGID.
   2> else:
      3> report Short BSR.
1> else if the number of padding bits is equal to or larger than the size of the Long BSR plus its subheader:
   2> report Long BSR for all LCGs which have data available for transmission.

For Padding BSR, the MAC entity for which logicalChannelGroup-IAB-Ext is configured by upper layers shall:
1> if the number of padding bits is equal to or larger than the size of the Extended Short BSR plus its subheader but smaller than the size of the Extended Long BSR plus its subheader:
   2> if more than one LCG has data available for transmission when the BSR is to be built:
      3> if the number of padding bits is smaller than the size of the Extended Long Truncated BSR with zero Buffer Size field plus its subheader:
         4> report Extended Short Truncated BSR of the LCG with the highest priority logical channel with data available for transmission.
      3> else:
         4> report Extended Long Truncated BSR of the LCG(s) with the logical channels having data available for transmission following a decreasing order of the highest priority logical channel (with or without data available for transmission) in each of these LCG(s), and in case of equal priority, in increasing order of LCGID.
   2> else:
      3> report Extended Short BSR.
1> else if the number of padding bits is equal to or larger than the size of the Extended Long BSR plus its subheader:
   2> report Extended Long BSR for all LCGs which have data available for transmission.

For BSR triggered by retxBSR-Timer expiry, the MAC entity considers that the logical channel that triggered the BSR is the highest priority logical channel that has data available for transmission at the time the BSR is triggered.

The MAC entity shall:
1> if the Buffer Status reporting procedure determines that at least one BSR has been triggered and not cancelled:
   2> if UL-SCH resources are available for a new transmission and the UL-SCH resources can accommodate the BSR MAC CE plus its subheader as a result of logical channel prioritization:
      3> instruct the Multiplexing and Assembly procedure to generate the BSR MAC CE(s) as defined in clause 6.1.3.1;
      3> start or restart periodicBSR-Timer except when all the generated BSRs are long or short Truncated or Extended long or short Truncated BSRs;
      3> start or restart retxBSR-Timer.
   2> if a Regular BSR has been triggered and logicalChannelSR-DelayTimer is not running:
      3> if there is no UL-SCH resource available for a new transmission; or
      3> if the MAC entity is configured with configured uplink grant(s) and the Regular BSR was triggered for a logical channel for which logicalChannelSR-Mask is set to false; or
      3> if the UL-SCH resources available for a new transmission do not meet the LCP mapping restrictions (see clause 5.4.3.1) configured for the logical channel that triggered the BSR:
         4> trigger a Scheduling Request.
NOTE 2: UL-SCH resources are considered available if the MAC entity has been configured with, receives, or determines an uplink grant. If the MAC entity has determined at a given point in time that UL-SCH resources are available, this need not imply that UL-SCH resources are available for use at that point in time.

A MAC PDU shall contain at most one BSR MAC CE, even when multiple events have triggered a BSR. The Regular BSR and the Periodic BSR shall have precedence over the padding BSR.

The MAC entity shall restart retxBSR-Timer upon reception of a grant for transmission of new data on any UL-SCH.

All triggered BSRs may be cancelled when the UL grant(s) can accommodate all pending data available for transmission but is not sufficient to additionally accommodate the BSR MAC CE plus its subheader. All BSRs triggered prior to MAC PDU assembly shall be cancelled when a MAC PDU is transmitted and this PDU includes a Long, Extended Long, Short, or Extended Short BSR MAC CE which contains buffer status up to (and including) the last event that triggered a BSR prior to the MAC PDU assembly.
NOTE 3: MAC PDU assembly can happen at any point in time between uplink grant reception and actual transmission of the corresponding MAC PDU. BSR and SR can be triggered after the assembly of a MAC PDU which contains a BSR MAC CE, but before the transmission of this MAC PDU. In addition, BSR and SR can be triggered during MAC PDU assembly.
NOTE 4: Void
NOTE 5: If a HARQ process is configured with cg-RetransmissionTimer and if the BSR is already included in a MAC PDU for transmission on configured grant by this HARQ process, but not yet transmitted by lower layers, it is up to UE implementation how to handle the BSR content.

[ . . . ]

6.1.3.1 Buffer Status Report MAC CEs

### FIG. 6.1.3.1-1 of 3GPP TS 38.321 V17.2.0, Entitled “Short BSR and Short Truncated BSR MAC CE”, is Reproduced as FIG. 13

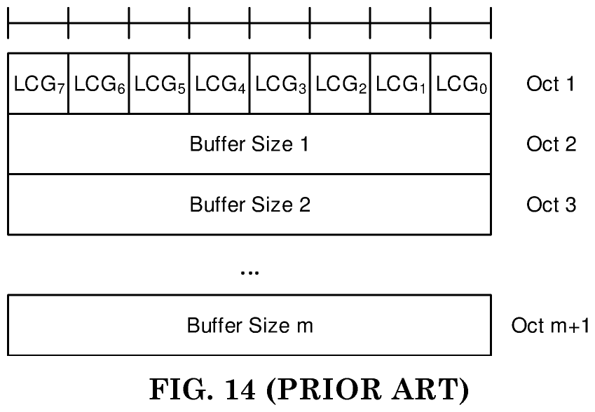

### FIG. 6.1.3.1-2 of 3GPP TS 38.321 V17.2.0, Entitled “Long BSR, Long Truncated BSR, and Preemptive BSR MAC CE”, is Reproduced as FIG. 14

LCG ID: The Logical Channel Group ID field identifies the group of logical channel(s) whose buffer status is being reported. The length of the field is 3 bits for the case of Short BSR and Short Truncated BSR formats, and 8 bits for the case of Extended Short BSR and Extended Short Truncated BSR formats;
LCGᵢ: For the Long BSR format, Extended Long BSR format, Pre-emptive BSR format, and Extended Pre-emptive BSR format, this field indicates the presence of the Buffer Size field for the logical channel group i. The LCGᵢ field set to 1 indicates that the Buffer Size field for the logical channel group i is reported. The LCGᵢ field set to 0 indicates that the Buffer Size field for the logical channel group i is not reported. For the Long Truncated BSR format and the Extended Long Truncated BSR format, this field indicates whether logical channel group i has data available. The LCGᵢ field set to 1 indicates that logical channel group i has data available. The LCGᵢ field set to 0 indicates that logical channel group i does not have data available;

[ . . . ]

5.22.1.6 Buffer Status Reporting

The Sidelink Buffer Status reporting (SL-BSR) procedure is used to provide the serving gNB with information about SL data volume in the MAC entity.

RRC configures the following parameters to control the SL-BSR:
sl-periodicBSR-Timer, configured by periodicBSR-Timer in sl-BSR-Config;
sl-retxBSR-Timer, configured by retxBSR-Timer in sl-BSR-Config;
sl-logicalChannelSR-DelayTimerApplied;
sl-logicalChannelSR-DelayTimer, configured by logicalChannelSR-DelayTimer in sl-BSR-Config;
sl-logicalChannelGroup.

Each logical channel which belongs to a Destination is allocated to an LCG as specified in TS 38.331 [5]. The maximum number of LCGs is eight.

The MAC entity determines the amount of SL data available for a logical channel according to the data volume calculation procedure in TSs 38.322 [3] and 38.323 [4].

An SL-BSR shall be triggered if any of the following events occur:
1> if the MAC entity has been configured with Sidelink resource allocation mode 1:
   2> SL data, for a logical channel which belongs to an LCG of a Destination, becomes available to the MAC entity; and either
      3> this SL data belongs to a logical channel with higher priority than the priorities of the logical channels containing available SL data which belong to any LCG belonging to the same Destination; or
      3> none of the logical channels which belong to an LCG belonging to the same Destination contains any available SL data.
      in which case the SL-BSR is referred below to as ‘Regular SL-BSR’;
   2> UL resources are allocated and number of padding bits remaining after a Padding BSR has been triggered is equal to or larger than the size of the SL-BSR MAC CE plus its subheader, in which case the SL-BSR is referred below to as ‘Padding SL-BSR’;
   2> sl-retxBSR-Timer expires, and at least one of the logical channels which belong to an LCG contains SL data, in which case the SL-BSR is referred below to as ‘Regular SL-BSR’; 2> sl-periodicBSR-Timer expires, in which case the SL-BSR is referred below to as ‘Periodic SL-BSR’.
1> else:
   2> Sidelink resource allocation mode 1 is configured by RRC and SL data is available for transmission in the RLC entity or in the PDCP entity, in which case the Sidelink BSR is referred below to as ‘Regular SL-BSR’.

For Regular SL-BSR, the MAC entity shall:
1> if the SL-BSR is triggered for a logical channel for which sl-logicalChannelSR-DelayTimerApplied with value true is configured by RRC:
   2> start or restart the sl-logicalChannelSR-DelayTimer.
1> else:
   2> if running, stop the sl-logicalChannelSR-DelayTimer.

For Regular and Periodic SL-BSR, the MAC entity shall:
1> if sl-PrioritizationThres is configured and the value of the highest priority of the logical channels that belong to any LCG and contain SL data for any Destination is lower than sl-PrioritizationThres; and
1> if ul-PrioritizationThres is configured and the value of the highest priority of the logical channels that belong to any LCG and contain UL data is equal to or higher than ul-PrioritizationThres according to clause 5.4.5:
   2> prioritize the LCG(s) for the Destination(s).
1> if the Buffer Status reporting procedure determines that at least one BSR has been triggered and not cancelled according to clause 5.4.5 and the UL grant cannot accommodate an SL-BSR MAC CE containing buffer status only for all prioritized LCGs having data available for transmission plus the subheader of the SL-BSR according to clause 5.4.3.1.3, in case the SL-BSR is considered as not prioritized:
   2> prioritize the SL-BSR for logical channel prioritization specified in clause 5.4.3.1;
   2> report Truncated SL-BSR containing buffer status for as many prioritized LCGs having data available for transmission as possible, taking the number of bits in the UL grant into consideration.
1> else if the number of bits in the UL grant is expected to be equal to or larger than the size of an SL-BSR containing buffer status for all LCGs having data available for transmission plus the subheader of the SL-BSR according to clause 5.4.3.1.3:
   2> report SL-BSR containing buffer status for all LCGs having data available for transmission.
1> else:
   2> report Truncated SL-BSR containing buffer status for as many LCGs having data available for transmission as possible, taking the number of bits in the UL grant into consideration.

For Padding SL-BSR:
1> if the number of padding bits remaining after a Padding BSR has been triggered is equal to or larger than the size of an SL-BSR containing buffer status for all LCGs having data available for transmission plus its subheader:
   2> report SL-BSR containing buffer status for all LCGs having data available for transmission;
1> else:
   2> report Truncated SL-BSR containing buffer status for as many LCGs having data available for transmission as possible, taking the number of bits in the UL grant into consideration.

For SL-BSR triggered by sl-retxBSR-Timer expiry, the MAC entity considers that the logical channel that triggered the SL-BSR is the highest priority logical channel that has data available for transmission at the time the SL-BSR is triggered.

The MAC entity shall:
1> if the sidelink Buffer Status reporting procedure determines that at least one SL-BSR has been triggered and not cancelled:
   2> if UL-SCH resources are available for a new transmission and the UL-SCH resources can accommodate the SL-BSR MAC CE plus its subheader as a result of logical channel prioritization according to clause 5.4.3.1:
      3> instruct the Multiplexing and Assembly procedure in clause 5.4.3 to generate the SL-BSR MAC CE(s);
      3> start or restart sl-periodicBSR-Timer except when all the generated SL-BSRs are Truncated SL-BSRs;
      3> start or restart sl-retxBSR-Timer.
   2> if a Regular SL-BSR has been triggered and sl-logicalChannelSR-DelayTimer is not running:
      3> if there is no UL-SCH resource available for a new transmission; or
      3> if UL-SCH resources are available for a new transmission and the UL-SCH resources cannot accommodate the SL-BSR MAC CE plus its subheader as a result of logical channel prioritization according to clause 5.4.3.1; or
      3> if the set of Subcarrier Spacing index values in sl-AllowedSCS-List, if configured for the logical channel that triggered the SL-BSR, does not include the Subcarrier Spacing index associated to the UL-SCH resources available for a new transmission; or
      3> if sl-MaxPUSCH-Duration, if configured for the logical channel that triggered the SL-BSR, is smaller than the PUSCH transmission duration associated to the UL-SCH resources available for a new transmission:
         4> trigger a Scheduling Request.
NOTE 1: UL-SCH resources are considered available if the MAC entity has been configured with, receives, or determines an uplink grant. If the MAC entity has determined at a given point in time that UL-SCH resources are available, this need not imply that UL-SCH resources are available for use at that point in time.

A MAC PDU shall contain at most one SL-BSR MAC CE, even when multiple events have triggered an SL-BSR. The Regular SL-BSR and the Periodic SL-BSR shall have precedence over the padding SL-BSR.

The MAC entity shall restart sl-retxBSR-Timer upon reception of an SL grant for transmission of new data on any SL-SCH.

All triggered SL-BSRs may be cancelled when the SL grant(s) can accommodate all pending data available for transmission. All BSRs triggered prior to MAC PDU assembly shall be cancelled when a MAC PDU is transmitted and this PDU includes an SL-BSR MAC CE which contains buffer status up to (and including) the last event that triggered an SL-BSR prior to the MAC PDU assembly. All triggered SL-BSRs shall be cancelled, and sl-retx-BSR-Timer and sl-periodic-BSR-Timer shall be stopped, when RRC configures Sidelink resource allocation mode 2.
NOTE 2: MAC PDU assembly can happen at any point in time between uplink grant reception and actual transmission of the corresponding MAC PDU. SL-BSR and SR can be triggered after the assembly of a MAC PDU which contains an SL-BSR MAC CE, but before the transmission of this MAC PDU. In addition, SL-BSR and SR can be triggered during MAC PDU assembly.

[ . . . ]

6.1.3.33 Sidelink Buffer Status Report MAC CEs

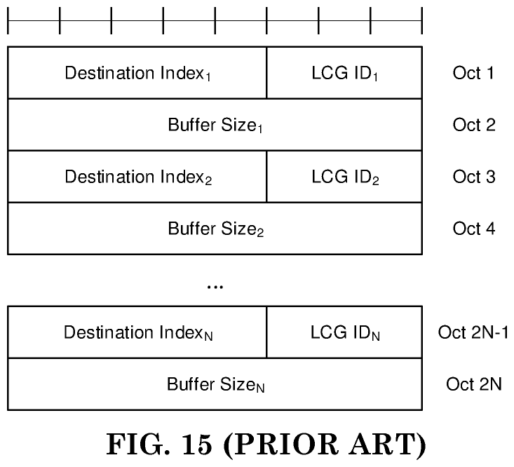

### FIG. 6.1.3.33-1 of 3GPP TS 38.321 V17.2.0, Entitled “SL-BSR and Truncated SL-BSR MAC Control Element”, is Reproduced as FIG. 15

[ . . . ]
Destination Index: The Destination Index field identifies the destination. The length of this field is 5 bits. The value is set to one index corresponding to SL destination identity associated to same destination reported in sl-TxResourceReqList, sl-TxResourceReqListDisc and sl-TxResourceReqListCommRelay, if present. The value is indexed sequentially from 0 in the same ascending order of SL destination identity in sl-TxResourceReqList, sl-TxResourceReqListDisc and sl-TxResourceReqListCommRelay as specified in TS 38.331 [5]. When multiple lists are reported, the value is indexed sequentially across all the lists in the same order as presented in SidelinkUElnformaitonNR message;
LCG ID: The Logical Channel Group ID field identifies the group of logical channel(s) whose SL buffer status is being reported. The length of the field is 3 bits;
Buffer Size: The Buffer Size field identifies the total amount of data available according to the data volume calculation procedure in TSs 38.322 [3] and 38.323 [4] across all logical channels of a logical channel group of a destination after the MAC PDU has been built (i.e. after the logical channel prioritization procedure, which may result the value of the Buffer Size field to zero). The amount of data is indicated in number of bytes. The size of the RLC headers and MAC subheaders are not considered in the buffer size computation. The length of this field is 8 bits. The values for the Buffer Size field are shown in Table 6.1.3.1-2, respectively. For the Truncated SL-BSR format the number of Buffer Size fields included is maximised, while not exceeding the number of padding bits.

[ . . . ]

3GPP RP-213585 is a new WID on NR sidelink relay enhancements for Release 18. The justification and objective in this WID are quoted below:

3 Justification

3GPP RAN approved a study item “Study on NR Sidelink Relay” in Rel-17 in order to cover the enhancements and solutions necessary to support the UE-to-network Relay and UE-to-UE Relay coverage extension, considering wider range of including V2X, Public Safety and commercial applications and services. The study outcome was documented in 3GPP TR 38.836, and it contains potential technical solutions for the sidelink relay with a conclusion that both Layer-2 based Relay architecture and Layer-3 based Relay architecture are feasible and a recommendation for their normative work. However, the follow-up Rel-17 work item “NR Sidelink Relay” included only limited features due to the lack of time. In particular, it supports only UE-to-Network relay and its service continuity solution is limited to intra-gNB direct-to-indirect and indirect-to-direct path switching in Layer-2 relay.

A study item for ProSe phase 2 is approved in SA in order to investigate further 5G system enhancements to support Proximity Services in Rel-18. RAN-side enhancements for sidelink relay is necessary in accordance with the SA work.

For better support of the use cases requiring sidelink relay, further enhancements are necessary in order to introduce the potential solutions identified during the Rel-17 study item. To be specific, support of UE-to-UE relay is essential for the sidelink coverage extension without relying on the use of uplink and downlink. Service continuity enhancements in UE-to-Network relay are also necessary in order to cover the mobility scenarios not supported in the Rel-17 WI. In addition, support of multi-path with relay, where a remote UE is connected to network via direct and indirect paths, has a potential to improve the reliability/robustness as well as throughput, so it needs to be considered as an enhancement area in Rel-18. This multi-path relay solution can also be utilized to for UE aggregation where a UE is connected to the network via direct path and via another UE using a non-standardized UE-UE interconnection. UE aggregation aims to provide applications requiring high UL bitrates on 5G terminals, in cases when normal UEs are too limited by UL UE transmission power to achieve required bitrate, especially at the edge of a cell. Additionally, UE aggregation can improve the reliability, stability and reduce delay of services as well, that is, if the channel condition of a terminal is deteriorating, another terminal can be used to make up for the traffic performance unsteadiness caused by channel condition variation.

4 Objective

4.1 Objective of Sl or Core Part Wl or Testing Part WI

The objective of this work item is to specify solutions that are needed to enhance NR Sidelink

Relay for the V2X, public safety and commercial use cases.
1. Specify mechanisms to support single-hop Layer-2 and Layer-3 UE-to-UE relay (i.e., source UE->relay UE->destination UE) for unicast [RAN2, RAN3, RAN4].
   A. Common part for Layer-2 and Layer-3 relay to be prioritized until RAN #98
      i. Relay discovery and (re)selection [RAN2, RAN4]
      ii. Signalling support for Relay and remote UE authorization if SA2 concludes it is needed [RAN3]
   B. Layer-2 relay specific part
      i. UE-to-UE relay adaptation layer design [RAN2]
      ii. Control plane procedures [RAN2]
      iii. QoS handling if needed, subject to SA2 progress [RAN2]
   Note 1A: This work should take into account the forward compatibility for supporting more than one hop in a later release.
   Note 1B: A remote UE is connected to only a single relay UE at a given time for a given destination UE.
2. Specify mechanisms to enhance service continuity for single-hop Layer-2 UE-to-Network relay for the following scenarios [RAN2, RAN3]:
   A. Inter-gNB indirect-to-direct path switching (i.e., “remote UE<-> relay UE A<->gNB X” to “remote UE<->gNB Y”)
   B. Inter-gNB direct-to-indirect path switching (i.e., “remote UE<->gNB X” to “remote UE<->relay UE A<->gNB Y”)
   C. Intra-gNB indirect-to-indirect path switching (i.e., “remote UE<-> relay UE A<->gNB X” to “remote UE<-> relay UE B<->gNB X”)
   D. Inter-gNB indirect-to-indirect path switching (i.e., “remote UE<-> relay UE A<->gNB X” to “remote UE<-> relay UE B<->gNB Y”)
   Note 2A: Scenario D is to be supported by reusing solutions for the other scenarios without specific optimizations.
3. Study the benefit and potential solutions for multi-path support to enhance reliability and throughput (e.g., by switching among or utilizing the multiple paths simultaneously) in the following scenarios [RAN2, RAN3]:
   A. A UE is connected to the same gNB using one direct path and one indirect path via 1) Layer-2 UE-to-Network relay, or 2) via another UE (where the UE-UE inter-connection is assumed to be ideal), where the solutions for 1) are to be reused for 2) without precluding the possibility of excluding a part of the solutions which is unnecessary for the operation for 2).
   Note 3A: Study on the benefit and potential solutions are to be completed in RAN #98 which will decide whether/how to start the normative work.
   Note 3B: UE-to-Network relay in scenario 1 reuses the Rel-17 solution as the baseline. Note 3C: Support of Layer-3 UE-to-Network relay in multi-path scenario is assumed to have no RAN impact and the work and solutions are subject to SA2 to progress.
4. Support of sidelink DRX for Layer-2 UE-to-Network sidelink relay operation if not done in Rel-17 [RAN2]
   Note 4A: This objective is to be checked in RAN #95e.
5. Specify RRM core requirements for relay discovery and (re)selection in UE-to-UE relay [RAN4]

This work will not consider specific enhancement for sidelink relay support of functionality specified in Rel-18 sidelink enhancements. If Rel-18 sidelink enhancements can be operated in relay without any special handling, they can be used in relaying operations.

According to 3GPP R2-2209301 and R3-225301, the current RAN2 & RAN3 agreements on multi-path transmission are as follows:

### RAN 2 #119-e

RAN2 anticipate benefits from multi-path in the following areas:
   Relay and direct multi-path operation (including both scenarios 1 and 2) can provide efficient path switching between direct path and indirect path
   The remote UE in multi-path operation can provide enhanced user data throughput and reliability compared to a single link
   gNB can offload the direct connection of the remote UE in congestion to indirect connection via the relay UE (e.g. at different intra/inter-frequency cells)
RAN2 can confirm the justifiable benefits that multi-path with relay and UE aggregation can improve the throughput and reliability/robustness, e.g., for UE at the edge of a cell, and UE with limited UL transmission power.
The terms “relay UE” and “remote UE” are used for scenarios 1 and 2. FFS if we would use additional terms specific to scenario 2.
Confirm the remote UE in Scenario 1 and the remote UE in Scenario 2 as follows:
   Scenario 1: the remote UE is connected to the same gNB using one direct path and one indirect path via 1) Layer-2 UE-to-Network relay,
   Scenario 2: the remote UE is connected to the same gNB using one direct path and one indirect path via 2) via another UE (where the UE-UE inter-connection is assumed to be ideal).
RAN2 assumes that the relation between remote UE and relay UE in scenario 2 is pre-configured or static and how the relation is pre-configured or static is out of the 3GPP scope.
RAN2 deprioritizes discussion on authorization and association mechanism between remote UE and relay UE in scenario 2.
Support the following cell deployment scenarios for multi-path relaying in Rel-18:
   Scenario C1: The relay UE and remote UE are served by a same cell.
   Scenario C2: The relay UE and remote UE are served by different intra-frequency cells of a same gNB
   Scenario C3: The relay UE and remote UE are served by different inter-frequency cells of a same gNB
Support the following sidelink scenarios for multi-path:
   Scenario S1: SL TX/RX and Uu share the same carrier at the remote UE.
   Scenario S2: SL TX/RX and Uu use different carriers at the remote UE.
   Scenario S3: SL TX/RX and Uu share the same carrier at the relay UE.
   Scenario S4: SL TX/RX and Uu use different carriers at the relay UE.
Support direct bearer (bearer mapped to direct path on Uu), indirect bearer (bearer mapped to indirect path via relay UE), and MP split bearer (bearer mapped to both paths, based on the existing split bearer framework).
For a MP split bearer in scenario 1, one PDCP entity at the remote UE is configured with one direct Uu RLC channel and one indirect PC5 RLC channel.
   For upstream, a PDCP entity delivers to a Uu RLC entity and a PC5 RLC entity with SRAP entity in the remote UE side.
   For downstream, a PDCP entity receives from a Uu RLC entity and a PC5 RLC entity with SRAP entity in the remote UE side.
FFS if we need to take decisions on the mapping of protocol entities in scenario 2.

### RAN3 #117-e

From RAN3 perspective, multi-path scenario should be supported in Rel-18.
Both intra-DU and inter-DU cases will be supported under the same gNB.
RAN3 waits for the RAN2 progress on how to define control plane and user plane scenarios for multi-path support.
RAN3 waits for the RAN2 progress on whether and how to define the Primary path in multi-path support.
Addition of direct/indirect path are supported as follows:
   Add direct path, after the establishment of the indirect path.
   Add indirect path, after the establishment of the direct path.
   This does not imply the exclusion of any other path addition possibility.
RAN3 will study the signaling impact on the direct or indirect path change under the same gNB for a UE connected via multi-path. The other mobility scenarios can be further considered based on RAN2 decision.
The following use cases are not supported in Rel-18.
   Configure two indirect paths
   More than two paths
   Inter-gNB multi-path support

UE-to-Network (U2N) Relay was introduced to NR R17. To support L2 UE-to-Network Relay, a L2 U2N Remote UE needs to connect with a L2 U2N Relay UE before it can establish an RRC connection with a gNB via the L2 UE-to-Network (U2N) Relay UE or before it is switched from direct path to indirect path (as discussed in 3GPP TS 38.300). Once the PC5 connection (or PC5 unicast link) between the Layer-2 (L2) U2N Remote UE and the L2 U2N Relay UE is established, a L2 ID of the Remote UE is known to the Relay UE.

Considering that multiple L2 U2N Remote UEs may communicate with the network via the same L2 U2N Relay UE, a SRAP layer is added above the PC5-RLC layer and the Uu-RLC layer to support L2 UE-to-Network Relay (as discussed in 3GPP TS 38.300). The PC5 Sidelink Relay Adaptation Protocol (SRAP) sublayer supports end-to-end Uu Radio Bearer (RB) identification for UL traffic. The identity information of L2 U2N Remote UE end-to-end Uu RB is included into the PC5 SRAP header by the L2 U2N Remote UE for the L2 U2N Relay UE to enable UL bearer mapping between L2 U2N Remote UE end-to-end Uu RBs and egress Uu Relay RLC channels. The Uu SRAP sublayer also supports L2 U2N Remote UE identification for UL traffic. The identity information of L2 U2N Remote UE end-to-end Uu RB and a local ID of the Remote UE are included in the Uu SRAP header for gNB to correlate the received packets for the specific Packet Data Convergence Protocol (PDCP) entity associated with the right end-to-end Uu Radio Bearer (RB) of the L2 U2N Remote UE.

According to 3GPP RP-213585, multi-path transmission (or communication) may be introduced in NR R18 and there may be two different scenarios of multi-path communication i.e. a UE is connected to the same gNB using one direct path and one indirect path via 1) a Layer-2 UE-to-Network relay, or 2) via another UE using a non-standardized UE-UE inter-connection. In the second scenario, the remote UE may be named as Anchor UE and the Relay UE may be named as Aggregated UE. According to the current RAN2 & RAN3 agreements, the relationship between Remote UE/Anchor UE and Relay UE/Aggregated UE may be relative static and could be pre-configured, which implies that the Relay UE/Aggregated UE could be known to the Remote UE/Anchor UE beforehand. And, the following bearer types may be supported for multi-path transmission no matter which scenario is applied:
(1) Direct bearer: bearer mapped to direct path on Uu,
(2) Indirect bearer: bearer mapped to indirect path via relay UE, and
(3) MP split bearer: bearer mapped to both paths.

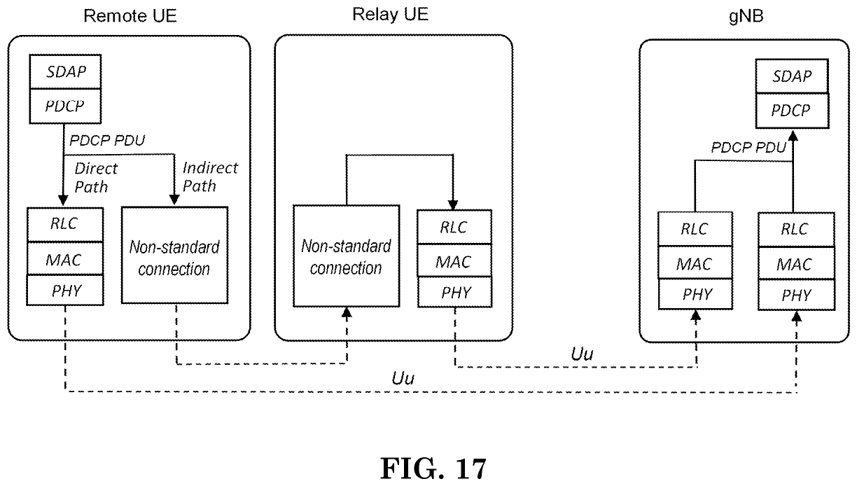

Suppose SRAP layers will be used on both the UE-UE link and the Relay-gNB link to support multi-path transmission for Scenario 1. And, it is very possible that no SRAP layer will be used on both the UE-UE link and the Relay-gNB link to support multi-path transmission for Scenario 2. FIGS. 16 and 17 illustrate the protocol stacks for supporting multi-path transmission Scenario 1 and Scenario 2, respectively. More specifically, FIG. 16 illustrates a protocol stack for multi-path transmission (Scenario 1) according to one exemplary embodiment, and FIG. 17 illustrates a protocol stack for multi-path transmission (Scenario 2) according to one exemplary embodiment.

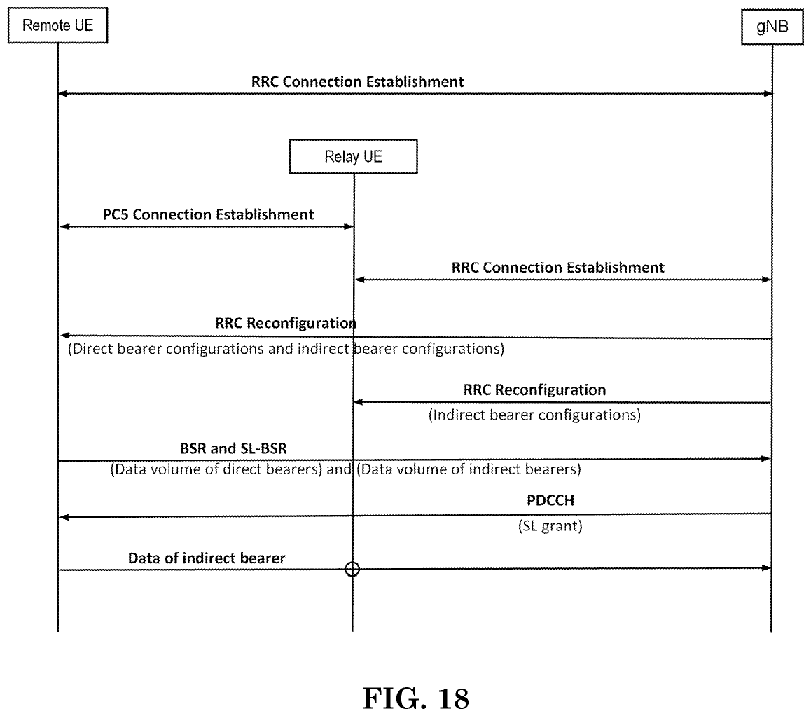

According to 3GPP TS 38.300, two sidelink (SL) resource allocation modes are supported: mode 1 (i.e. Scheduled resource allocation) and mode 2 (i.e. UE autonomous resource selection). In mode 1, the sidelink resource allocation is provided by the network. In mode 2, UE decides the SL transmission resources in the resource pool(s). In Rel-17 U2N relay, only resource allocation mode 2 can be used for the remote UE. For Scenario 1 in multi-path, it is possible for the gNB to schedule sidelink (SL) resources of the indirect path to the remote UE via the direct path. Thus, 3GPP R2-2209372 proposes resource allocation mode 1 can also be used for the remote UE. To support resource allocation mode 1, the remote UE needs to report Sidelink Buffer Status Report (SL-BSR) to the gNB. In R16 dual connectivity (DC) (as discussed in 3GPP TS 37.340), BSR reporting is independently performed per cell group by the corresponding Medium Access Control (MAC) entity associated with each cell group. Thus, in case of Master Cell Group (MCG) bearers, buffer sizes of the MCG bearers are included in the BSR reported to the Master Node (MN) via radio resource of the MCG. And, in case of Secondary Cell Group (SCG) bearers, buffer sizes of the SCG bearers are included in the BSR reported to the SN via radio resource of the SCG. If a similar concept is applied for Scenario 1 in multi-path, the remote UE would report BSR to the gNB via the direct path and report SL-BSR to the gNB via the indirect path. However, it would induce more complexity and delay for transmitting an SL-BSR MAC control element to the gNB via the relay UE (i.e. the indirect path). Instead, it is better for the remote UE to report both the BSR and the SL-BSR to the gNB via the direct path. FIG. 18 illustrates an example of the above solution. In particular, FIG. 18 illustrates radio bearer configuration and BSR and SL-BSR reporting to support Scenario 1 according to one exemplary embodiment.

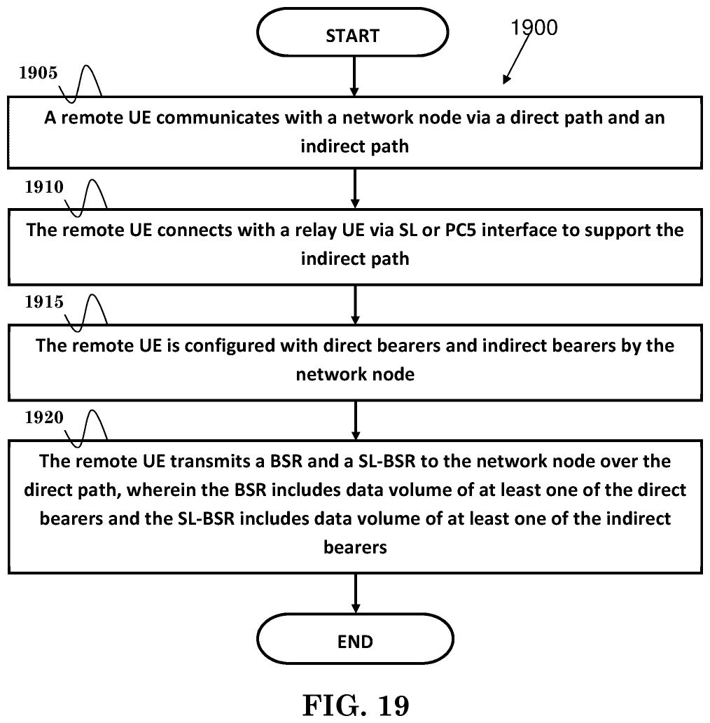

FIG. 19 is a flow chart 1900 of a method for supporting MP transmission from the perspective of a remote UE. In step 1905, a remote UE communicates with a network node via a direct path and an indirect path. In step 1910, the remote UE connects with a relay UE via SL or PC5 interface to support the indirect path. In step 1915, the remote UE is configured with direct bearers and indirect bearers by the network node. In step 1920, the remote UE transmits a buffer status report (BSR) and a SL-BSR to the network node over the direct path, wherein the BSR includes data volume of at least one of the direct bearers and the SL-BSR includes data volume of at least one of the indirect bearers.

In one embodiment, a direct bearer may be a radio bearer mapped to the direct path, and an indirect bearer may be a radio bearer mapped to the indirect path. In one embodiment, each direct bearer could be mapped to a first PDCP entity and a RLC entity. The first PDCP entity and the RLC entity could be associated with a logical channel belonging to a logical channel group. The data volume of the at least one of the direct bearers may mean data volume in at least one first PDCP entity and at least one RLC entity associated with the at least one of the direct bearers.

In one embodiment, each indirect bearer could be mapped to a second PDCP entity and a PC5 RLC entity. The second PDCP entity and the PC5 RLC entity may be associated with a SL logical channel belonging to a SL logical channel group. The data volume of the at least one of the indirect bearers may mean data volume in at least one second PDCP entity and at least one PC5 RLC entity associated with the at least one of the indirect bearers.

In one embodiment, the remote UE may receive an SL grant from the network node over the direct path after transmitting the SL-BSR. Then, the remote UE may transmit a data packet from the at least one of the indirect bearers to the relay UE, based on the SL grant, for forwarding to the network node.

Referring back to FIGS. 3 and 4, in one exemplary embodiment of a method for supporting MP transmission from the perspective of a remote UE, the remote UE 300 includes a program code 312 stored in the memory 310. The CPU 308 could execute program code 312 to enable the remote UE (i) to communicate with a network node via a direct path and an indirect path, (ii) to connect with a relay UE via SL or PC5 interface to support the indirect path, (iii) to be configured with direct bearers and indirect bearers by the network node, and (iv) to transmit a BSR and a SL-BSR to the network node over the direct path, wherein the BSR includes data volume of at least one of the direct bearers and the SL-BSR includes data volume of at least one of the indirect bearers. Furthermore, the CPU 308 can execute the program code 312 to perform all of the above-described actions and steps or others described herein.

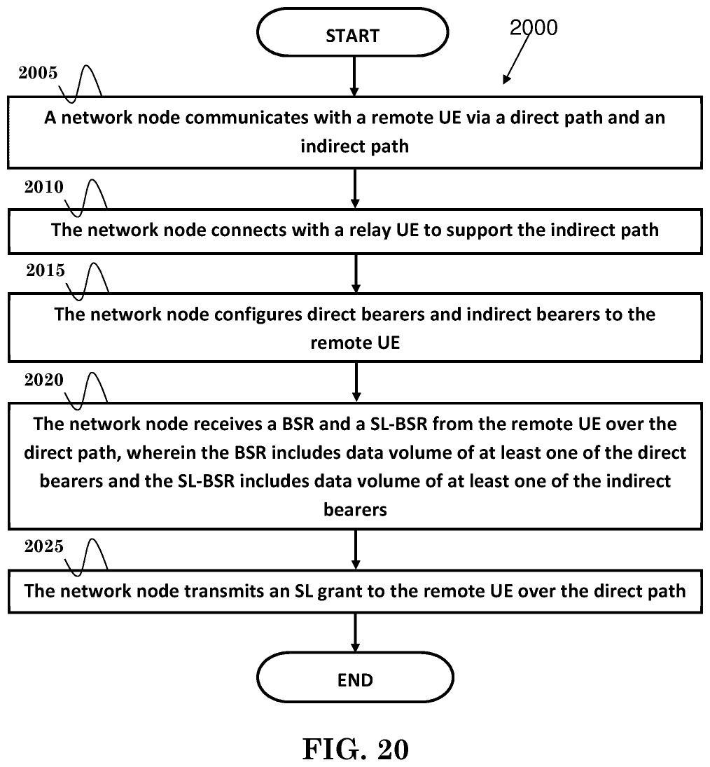

FIG. 20 is a flow chart 2000 of a method for supporting MP transmission from the perspective of a network node. In step 2005, a network node communicates with a remote UE via a direct path and an indirect path. In step 2010, the network node connects with a relay UE to support the indirect path. In step 2015, the network node configures direct bearers and indirect bearers to the remote UE. In step 2020, the network node receives a BSR and a SL-BSR from the remote UE over the direct path, wherein the BSR includes data volume of at least one of the direct bearers and the SL-BSR includes data volume of at least one of the indirect bearers. In step 2025, the network node transmits an SL grant to the remote UE over the direct path.

In one embodiment, a direct bearer may be a radio bearer mapped to the direct path, and an indirect bearer may be a radio bearer mapped to the indirect path. In one embodiment, each direct bearer may be mapped to a first PDCP entity and a RLC entity. The first PDCP entity and the RLC entity could be associated with a logical channel belonging to a logical channel group. The data volume of the at least one of the direct bearers may mean data volume in at least one first PDCP entity and at least one RLC entity associated with the at least one of the direct bearers.

In one embodiment, each indirect bearer may be mapped to a second PDCP entity and a PC5 RLC entity. The second PDCP entity and the PC5 RLC entity could be associated with an SL logical channel belonging to an SL logical channel group. The data volume of the at least one of the indirect bearers may mean data volume in at least one second PDCP entity and at least one PC5 RLC entity associated with the at least one of the indirect bearers.

In one embodiment, the network node may receive a data packet from the at least one of the indirect bearers via the relay UE after transmitting the SL grant to the remote UE.

Referring back to FIGS. 3 and 4, in one exemplary embodiment of a method for supporting MP transmission from the perspective of a network node, the network node 300 includes a program code 312 stored in the memory 310. The CPU 308 could execute program code 312 to enable the network node (i) to communicate with a remote UE via a direct path and an indirect path, (ii) to connect with a relay UE to support the indirect path, (iii) to configure direct bearers and indirect bearers to the remote UE, (iv) to receive a BSR and a SL-BSR from the remote UE over the direct path, wherein the BSR includes data volume of at least one of the direct bearers and the SL-BSR includes data volume of at least one of the indirect bearers, and (v) to transmit an SL grant to the remote UE over the direct path. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for supporting multi-path (MP) transmission, comprising:
a remote User Equipment (UE) communicates with a network node via a direct path and an indirect path;
the remote UE connects with a relay UE via sidelink (SL) or PC5 interface to support the indirect path;
the remote UE is configured with direct bearers and indirect bearers by the network node; and
the remote UE transmits a buffer status report (BSR) and a SL-BSR to the network node over the direct path, wherein the BSR includes data volume of at least one of the direct bearers and the SL-BSR includes data volume of at least one of the indirect bearers.

2. The method of claim 1, wherein a direct bearer is a radio bearer mapped to the direct path and an indirect bearer is a radio bearer mapped to the indirect path.

3. The method of claim 1, wherein each direct bearer is mapped to a first Packet Data Convergence Protocol (PDCP) entity, and a Radio Link Control (RLC) entity.

4. The method of claim 3, wherein the first PDCP entity and the RLC entity are associated with a logical channel belonging to a logical channel group.

5. The method of claim 3, wherein data volume of the at least one of the direct bearers means data volume in at least one first PDCP entity and at least one RLC entity associated with the at least one of the direct bearers.

6. The method of claim 1, wherein each indirect bearer is mapped to a second Packet Data Convergence Protocol (PDCP) entity and a PC5 Radio Link Control (RLC) entity.

7. The method of claim 6, wherein the second PDCP entity and the PC5 RLC entity are associated with a SL logical channel belonging to a SL logical channel group.

8. The method of claim 6, wherein data volume of the at least one of the indirect bearers means data volume in at least one second PDCP entity and at least one PC5 RLC entity associated with the at least one of the indirect bearers.

9. A remote User Equipment (UE) for supporting multi-path (MP) transmission, comprising:
a control circuit;
a processor installed in the control circuit; and
a memory installed in the control circuit and operatively coupled to the processor;
wherein the processor is configured to execute a program code stored in the memory to:
communicate with a network node via a direct path and an indirect path;
connect with a relay UE via sidelink (SL) or PC5 interface to support the indirect path;
be configured with direct bearers and indirect bearers by the network node; and
transmit a buffer status report (BSR) and a SL-BSR to the network node over the direct path, wherein the BSR includes data volume of at least one of the direct bearers and the SL-BSR includes data volume of at least one of the indirect bearers.

10. The remote UE of claim 9, wherein a direct bearer is a radio bearer mapped to the direct path and an indirect bearer is a radio bearer mapped to the indirect path.

11. The remote UE of claim 9, wherein each direct bearer is mapped to a first Packet Data Convergence Protocol (PDCP) entity, and a Radio Link Control (RLC) entity.

12. The remote UE of claim 11, wherein the first PDCP entity and the RLC entity are associated with a logical channel belonging to a logical channel group.

13. The remote UE of claim 11, wherein data volume of the at least one of the direct bearers means data volume in at least one first PDCP entity and at least one RLC entity associated with the at least one of the direct bearers.

14. The remote UE of claim 9, wherein each indirect bearer is mapped to a second Packet Data Convergence Protocol (PDCP) entity and a PC5 Radio Link Control (RLC) entity.

15. The remote UE of claim 14, wherein the second PDCP entity and the PC5 RLC entity are associated with an SL logical channel belonging to an SL logical channel group.

16. The remote UE of claim 14, wherein data volume of the at least one of the indirect bearers means data volume in at least one second PDCP entity and at least one PC5 RLC entity associated with the at least one of the indirect bearers.

17. A method for supporting multi-path (MP) transmission, comprising:
a network node communicates with a remote User Equipment (UE) via a direct path and an indirect path;
the network node connects with a relay UE to support the indirect path;
the network node configures direct bearers and indirect bearers to the remote UE;
the network node receives a buffer status report (BSR) and a sidelink-BSR (SL-BSR) from the remote UE over the direct path, wherein the BSR includes data volume of at least one of the direct bearers and the SL-BSR includes data volume of at least one of the indirect bearers; and
the network node transmits an SL grant to the remote UE over the direct path.

18. The method of claim 17, wherein a direct bearer is a radio bearer mapped to the direct path, and an indirect bearer is a radio bearer mapped to the indirect path.

19. The method of claim 17, wherein each direct bearer is mapped to a first Packet Data Convergence Protocol (PDCP) entity and a Radio Link Control (RLC) entity.

20. The method of claim 19, wherein the first PDCP entity and the RLC entity are associated with a logical channel belonging to a logical channel group.

21. The method of claim 19, wherein data volume of the at least one of the direct bearers means data volume in at least one first PDCP entity and at least one RLC entity associated with the at least one of the direct bearers.

22. The method of claim 17, wherein each indirect bearer is mapped to a second Packet Data Convergence Protocol (PDCP) entity and a PC5 Radio Link Control (RLC) entity.

23. The method of claim 22, wherein the second PDCP entity and the PC5 RLC entity are associated with an SL logical channel belonging to an SL logical channel group.

24. The method of claim 22, wherein data volume of the at least one of the indirect bearers means data volume in at least one second PDCP entity and at least one PC5 RLC entity associated with the at least one of the indirect bearers.
